(19) United States
(12) Patent Application Publication
(10) Pub. No.: US 2024/0163152 A1
(43) Pub. Date: May 16, 2024

(54) COMMUNICATION PROCESSING METHOD AND COMMUNICATION PROCESSING APPARATUS

(71) Applicant: HUAWEI TECHNOLOGIES CO., LTD., Shenzhen (CN)

(72) Inventors: Xiaolu WANG, Hangzhou (CN); Hejia LUO, Hangzhou (CN); Rong LI, Boulogne Billancourt (FR); Jun WANG, Hangzhou (CN)

(21) Appl. No.: 18/423,504

(22) Filed: Jan. 26, 2024

Related U.S. Application Data
(63) Continuation of application No. PCT/CN2022/106436, filed on Jul. 19, 2022.

(30) Foreign Application Priority Data
Jul. 29, 2021 (CN) 202110864933.5

(51) Int. Cl. H04L 27/26; H04W 28/26

(52) U.S. Cl. CPC H04L 27/2618; H04W 28/26

(57) ABSTRACT

Embodiments of this application disclose a communication processing method, including: A first communication device determines a first tone reservation pattern. The first communication device communicates a data signal by using the first tone reservation pattern. The first tone reservation pattern is determined based on a first bandwidth part BWP, or the first tone reservation pattern is determined based on a first beam. The first bandwidth part is used for communicating the data signal between the first communication device and a second communication device, and the first beam is used for communicating the data signal between the first communication device and the second communication device. It can be learned that the first tone reservation pattern is more suitable for the first communication device and the second communication device.

### CROSS-REFERENCE TO RELATED APPLICATIONS

This application is a continuation of International Application No. PCT/CN2022/106436, filed on Jul. 19, 2022, which claims priority to Chinese Patent Application No. 202110864933.5, fled on Jul. 29, 2021. The disclosures of the aforementioned applications are hereby incorporated by reference in their entireties.

### TECHNICAL FIELD

This application relates to the field of communication technologies, and in particular, to a communication processing method and a communication processing apparatus.

### BACKGROUND

In a communication system, a high power amplifier (high power amplifier, HPA) at a transmitting end works near a linear saturation region, to improve power efficiency of the HPA. If the communication system uses an orthogonal frequency division multiplexing (orthogonal frequency division multiplexing, OFDM) waveform to communicate data, the communication system has a disadvantage of a high peak-to-average power ratio (peak-to-average power ratio, PAPR). When the HPA works near the saturation region, there is a specific probability that a signal input to the HPA enters a non-linear region, resulting in non-linear distortion. The non-linear distortion causes in-band distortion and out-of-band radiation. This affects accuracy of decoding at a receiving end and causes interference to a user on an adjacent channel.

Currently, a tone reservation (tone reservation, TR) technology may be used to suppress PARA of a signal. Therefore, how to communicate data by using a tone reservation pattern to improve communication transmission performance is an urgent problem to be resolved currently.

### SUMMARY

Embodiments of this application provide a communication processing method and a communication processing apparatus, to suppress PARA of a signal and improve communication transmission performance.

A first aspect of embodiments of this application provides a communication processing method, including:

A first communication device determines a first tone reservation pattern (tone reservation pattern, TR). The first communication device communicates a data signal by using the first tone reservation pattern. The first tone reservation pattern is determined based on a first bandwidth part, or the first tone reservation pattern is determined based on a first beam. The first bandwidth part is used for communicating the data signal between the first communication device and a second communication device, and the first beam is used for communicating the data signal between the first communication device and the second communication device.

In the foregoing technical solution, the first tone reservation pattern is determined based on the first bandwidth part, or the first tone reservation pattern is determined based on the first beam. The first tone pattern is more suitable for the first communication device and the second communication device. The first communication device may communicate the data signal by using the first tone reservation pattern to suppress PARA of a signal and improve communication transmission performance.

In a possible implementation, that a first communication device determines a first tone reservation pattern includes:

The first communication device obtains first configuration information, where the first configuration information indicates the first tone reservation pattern corresponding to the first bandwidth part. The first communication device determines the first tone reservation pattern based on the first configuration information.

In the foregoing implementation, the first configuration information indicates the first tone reservation pattern corresponding to the first bandwidth part. It can be learned that the first tone reservation pattern indicated by the first configuration information is more suitable for the first communication device, so that the first communication device communicates the data signal by using the first tone reservation pattern to suppress the PARA of the signal. In this way, the communication transmission performance is improved. The foregoing provides a specific implementation in which the first communication device determines the first tone reservation pattern, to provide a basis for implementing the solution.

In another possible implementation, that a first communication device determines a first tone reservation pattern includes:

The first communication device determines, from a plurality of tone reservation patterns based on a first mapping relationship, the first tone reservation pattern corresponding to the first bandwidth part, where the first mapping relationship is a mapping relationship between a tone reservation pattern and a bandwidth part.

In the foregoing implementation, the first communication device determines, based on the first mapping relationship, the first tone reservation pattern corresponding to the first bandwidth part. The first tone reservation pattern is more suitable for the first communication device, so that the first communication device communicates the data signal by using the first tone reservation pattern to suppress the PARA of the signal. In this way, the communication transmission performance is improved. The foregoing provides another specific implementation in which the first communication device determines the first tone reservation pattern, to provide a basis for implementing the solution.

In another possible implementation, that a first communication device determines a first tone reservation pattern includes:

The first communication device determines, from a plurality of tone reservation patterns based on a second mapping relationship, the first tone reservation pattern corresponding to the first beam, where the second mapping relationship is a mapping relationship between a tone reservation pattern and a beam.

In the foregoing implementation, the first communication device determines, based on the second mapping relationship, the first tone reservation pattern corresponding to the first beam. The first tone reservation pattern is more suitable for the first communication device, so that the first communication device communicates the data signal by using the first tone reservation pattern to suppress the PARA of the signal. In this way, the communication transmission performance is improved. The foregoing provides another specific implementation in which the first communication device determines the first tone reservation pattern, to improve diversity and integrity of the solution.

In another possible implementation, that a first communication device determines a first tone reservation pattern includes:

The first communication device determines, from a plurality of tone reservation patterns based on a third mapping relationship, the first tone reservation pattern corresponding to the first bandwidth part, where the third mapping relationship includes a mapping relationship between a tone reservation pattern and a plurality of bandwidth parts corresponding to each of a plurality of beams.

In the foregoing implementation, the first communication device determines, based on the third mapping relationship, the first tone reservation pattern corresponding to the first bandwidth part. The first tone reservation pattern is more suitable for the first communication device, so that the first communication device communicates the data signal by using the first tone reservation pattern to suppress the PARA of the signal. In this way, the communication transmission performance is improved. The foregoing provides another specific implementation in which the first communication device determines the first tone reservation pattern, to improve diversity and integrity of the solution.

In another possible implementation, a reference signal is communicated between the first communication device and the second communication device by using a first reference signal pattern; and that a first communication device determines a first tone reservation pattern includes:

The first communication device determines, from a plurality of tone reservation patterns based on a fourth mapping relationship and the first bandwidth part, a tone reservation pattern corresponding to the first reference signal pattern, where the fourth mapping relationship is a mapping relationship that is between a tone reservation pattern and a reference signal pattern and that is used when the first communication device and the second communication device use each of a plurality of bandwidth parts.

In the foregoing implementation, the first communication device determines, based on the fourth mapping relationship, the tone reservation pattern corresponding to the first reference signal pattern. The first tone reservation pattern is more suitable for the first communication device, so that the first communication device communicates the data signal by using the first tone reservation pattern to suppress the PARA of the signal. In this way, the communication transmission performance is improved. The foregoing provides another specific implementation in which the first communication device determines the first tone reservation pattern, to improve diversity and integrity of the solution.

In another possible implementation, before the first communication device determines the first tone reservation pattern, the method further includes:

The first communication device determines whether to communicate the data signal by using the tone reservation pattern.

If the first communication device determines to communicate the data signal by using the tone reservation pattern, the step in which a first communication device determines a first tone reservation pattern is performed.

In this possible implementation, the first communication device may first determine whether the data signal needs to be communicated by using the tone reservation pattern. This avoids that the first communication device communicates the data signal by using the tone reservation pattern in an unnecessary case, to save network resources.

In another possible implementation, that the first communication device determines whether to communicate the data signal by using the tone reservation pattern includes:
obtaining first indication information; and determining, based on the first indication information, whether to communicate the data signal by using the tone reservation pattern.

The foregoing implementation provides a specific determining manner of determining, based on the first indication information, whether to communicate the data signal by using the tone reservation pattern. In this way, a determining process of the first communication device is implemented, to improve feasibility of the solution.

In another possible implementation, the first indication information is carried in a broadcast message.

In this possible implementation, a carrier of the first indication information is shown. The first indication information is carried by using the broadcast message, and a new message does not need to be redefined to send the first indication information, to improve practicability of the solution.

In another possible implementation, the broadcast message includes a system information block (system information block, SIB 1) or a master system information block (master information block, MIB).

In this possible implementation, the broadcast message may be the SIB 1 or the MIB, to facilitate indicating the first communication device to determine, in an initial access process, whether to communicate the data signal by using the tone reservation pattern.

In another possible implementation, the first indication information indicates location information of a third communication device, where the third communication device is used for communication between the first communication device and the second communication device.

That the first communication device determines, based on the first indication information, whether to communicate the data signal by using the tone reservation pattern includes:

The first communication device determines, based on the location information of the third communication device, whether to communicate the data signal by using the tone reservation pattern.

In the foregoing implementation, the first communication device determines, based on the location information of the third communication device, whether to communicate the data signal by using the tone reservation pattern. This helps the first communication device determine, in a specific scenario, whether the data signal needs to be communicated by using the tone reservation pattern, to improve the communication transmission performance. For example, the third communication device is a satellite. When an orbit height of the satellite is large, the first communication device may communicate the data signal by using the tone reservation pattern, to increase a signal-to-noise ratio of a signal received by the second communication device.

In another possible implementation, the first indication information indicates to the first communication device whether to communicate, by using the tone reservation pattern, a data signal carried in each of a plurality of beams, where the plurality of beams include the first beam.

In another possible implementation, if the first communication device and the second communication device switch from the first bandwidth part to a second bandwidth part, the method further includes:

The first communication device determines a second tone reservation pattern based on the second bandwidth part. The first communication device communicates the data signal based on the second tone reservation pattern.

In the foregoing implementation, the first communication device switches the bandwidth part. The first communication device may update the tone reservation pattern based on the second bandwidth part to which the first communication device switches. In this way, an updated tone reservation pattern is more suitable for the first communication device and the second communication device. The first communication device communicates the data signal based on the updated tone reservation pattern, to better suppress the PARA of the signal.

In another possible implementation, if the first communication device and the second communication device switch from the first beam to a second beam, the method further includes:

The first communication device correspondingly determines a third tone reservation pattern based on the second beam. The first communication device communicates the data signal based on the second tone reservation pattern.

In the foregoing implementation, the first communication device switches the beam. The first communication device may update the tone reservation pattern based on the second beam to which the first communication device switches. In this way, the updated tone reservation pattern is more suitable for the first communication device and the second communication device. The first communication device communicates the data signal based on the updated tone reservation pattern, to better suppress the PARA of the signal.

In another possible implementation, the first beam corresponds to the first bandwidth part and a third bandwidth part, the first bandwidth part corresponds to the first tone reservation pattern, and the third bandwidth part corresponds to a fourth tone reservation pattern. If the first communication device and the second communication device switch, on the first beam, from the first bandwidth part to the third bandwidth part, the method further includes:

The first communication device determines the fourth tone reservation pattern based on the third bandwidth part. The first communication device communicates the data signal based on the fourth tone reservation pattern.

In the foregoing implementation, the first communication device switches the bandwidth part on the first beam. The first communication device may update the tone reservation pattern based on the bandwidth part to which the first communication device switches on the first beam. In this way, the updated tone reservation pattern is more suitable for the first communication device and the second communication device. The first communication device communicates the data signal based on the updated tone reservation pattern, to better suppress the PARA of the signal.

In another possible implementation, if on a same time domain resource, a reserved carrier in the first tone reservation pattern overlaps a carrier that is on the first communication device and that is used for communicating the reference signal, that the first communication device communicates a data signal by using the first tone reservation pattern includes:

The first communication device punctures an overlapping reserved carrier in the first tone reservation pattern to obtain a fifth tone reservation pattern, where the overlapping reserved carrier is a reserved carrier that is in the first tone reservation pattern and that overlaps the carrier used for communicating the reference signal. The first communication device communicates the data signal based on the fifth tone reservation pattern.

It can be learned that the first communication device punctures the first tone reservation pattern, and then communicates the data signal by using the fifth tone reservation pattern obtained through puncturing. In other words, this application provides a new rule for using the tone reservation pattern, and the tone reservation pattern has a puncturing feature. The first communication device does not need to store or configure a plurality of sets of tone reservation patterns, to reduce storage overheads of the first communication device.

In another possible implementation, the method further includes:

The first communication device obtains second configuration information, where the second configuration information includes at least one of the following configuration parameters: a plurality of tone reservation patterns, indexes of the plurality of tone reservation patterns, the mapping relationship between a tone reservation pattern and a reference signal pattern when the first communication device and the second communication device use each of the plurality of bandwidth parts, the mapping relationship between a tone reservation pattern and a bandwidth part, the mapping relationship between a tone reservation pattern and a beam, and the mapping relationship between a tone reservation pattern and a plurality of bandwidth parts corresponding to a beam.

In the foregoing implementation, the first communication device may obtain the second configuration information, to determine the configuration parameter included in the second configuration information, so that the first communication device determines the first tone reservation pattern and communicates the data signal by using the first tone reservation pattern. In this way, the communication transmission performance is improved.

In another possible implementation, any one of the configuration parameters included in the second configuration information is carried in any one of the following signaling: the SIB 1, the MIB, radio control resource control (radio resource control, RRC) signaling, (downlink control information, DCI), group DCI, a media access control control element (media access control control element, MAC CE), or a timing advance command (timing advance command, TAC). In the foregoing implementation, some possible carriers of the second configuration information are shown, to provide a basis for implementing the solution.

A second aspect of embodiments of this application provides a communication processing method, including:

A second communication device determines a first tone reservation pattern. The second communication device communicates a data signal by using the first tone reservation pattern. The first tone reservation pattern is determined based on a first bandwidth part, or the first tone reservation pattern is determined based on a first beam. The first bandwidth part is used for communicating the data signal between a first communication device and the second communication device, and the first beam is used for communicating the data signal between the first communication device and the second communication device.

In the foregoing technical solution, the first tone reservation pattern is determined based on the first bandwidth part, or the first tone reservation pattern is determined based on the first beam. The first tone pattern is more suitable for the first communication device and the second communication device. The second communication device may communicate the data signal by using the first tone reservation pattern to suppress PARA of a signal and improve communication transmission performance.

In a possible implementation, that a second communication device determines a first tone reservation pattern includes:

The second communication device determines, from a plurality of tone reservation patterns based on a first mapping relationship, the first tone reservation pattern corresponding to the first bandwidth part, where the first mapping relationship is a correspondence between a tone reservation pattern and a bandwidth part.

In the foregoing implementation, the second communication device determines, based on the first mapping relationship, the first tone reservation pattern corresponding to the first bandwidth part. The first tone reservation pattern is more suitable for the first communication device, so that the second communication device communicates the data signal by using the first tone reservation pattern to suppress the PARA of the signal. In this way, the communication transmission performance is improved. The foregoing provides another specific implementation in which the second communication device determines the first tone reservation pattern, to provide a basis for implementing the solution.

In another possible implementation, that a second communication device determines a first tone reservation pattern includes:

The second communication device determines, from the plurality of tone reservation patterns based on a second mapping relationship, the first tone reservation pattern corresponding to the first beam, where the second mapping relationship is a mapping relationship between a tone reservation pattern and a beam.

In the foregoing implementation, the second communication device determines, based on the second mapping relationship, the first tone reservation pattern corresponding to the first beam. The first tone reservation pattern is more suitable for the second communication device, so that the second communication device communicates the data signal by using the first tone reservation pattern to suppress the PARA of the signal. In this way, the communication transmission performance is improved. The foregoing provides another specific implementation in which the second communication device determines the first tone reservation pattern, to improve diversity and integrity of the solution.

In another possible implementation, that a second communication device determines a first tone reservation pattern includes:

The second communication device determines, from the plurality of tone reservation patterns based on a third mapping relationship, the first tone reservation pattern corresponding to the first bandwidth part, where the third mapping relationship includes a mapping relationship between the tone reservation pattern and a plurality of bandwidth parts corresponding to each of a plurality of beams.

In the foregoing implementation, the second communication device determines, based on the third mapping relationship, the first tone reservation pattern corresponding to the first bandwidth part. The first tone reservation pattern is more suitable for the first communication device, so that the second communication device communicates the data signal by using the first tone reservation pattern to suppress the PARA of the signal. In this way, the communication transmission performance is improved. The foregoing provides another specific implementation in which the second communication device determines the first tone reservation pattern, to improve the diversity and the integrity of the solution.

In another possible implementation, that a reference signal is communicated between the first communication device and the second communication device by using a first reference signal pattern; and that a second communication device determines a first tone reservation pattern includes:

The second communication device determines, from a plurality of tone reservation patterns based on a fourth mapping relationship and the first bandwidth part, a tone reservation pattern corresponding to the first reference signal pattern, where the fourth mapping relationship is a mapping relationship that is between the tone reservation pattern and a reference signal pattern and that is used when the first communication device and the second communication device use each of the plurality of bandwidth parts.

In the foregoing implementation, the second communication device determines, based on the fourth mapping relationship and the first bandwidth part, the tone reservation pattern corresponding to the first reference signal pattern. The first tone reservation pattern is more suitable for the first communication device, so that the second communication device communicates the data signal by using the first tone reservation pattern to suppress the PARA of the signal. In this way, the communication transmission performance is improved. The foregoing provides another specific implementation in which the second communication device determines the first tone reservation pattern, to improve the diversity and the integrity of the solution.

In another possible implementation, the method further includes:

The second communication device sends first configuration information to the first communication device, where the first configuration information indicates the first tone reservation pattern corresponding to the first bandwidth part.

In the foregoing implementation, the second communication device may indicate the first tone reservation pattern to the first communication device, so that the first communication device determines the first tone reservation pattern. In this way, consensus between two communication parties is reached by negotiating, communication transmission is performed normally, to improve the communication transmission performance.

In another possible implementation, the method further includes:

The second communication device sends first indication information to the first communication device, where the first indication information indicates whether to communicate the data signal by using a tone reservation pattern.

In the foregoing implementation, the second communication device indicates, to the first communication device, whether to communicate the data signal by using the tone reservation pattern. In this way, a determining process of the first communication device is implemented, to improve feasibility of the solution.

In another possible implementation, the first indication information is carried in a broadcast message. In this possible implementation, a carrier of the first indication information is shown. The first indication information is carried by using the broadcast message, and a new message does not need to be redefined to send the first indication information, to improve practicability of the solution.

In another possible implementation, the broadcast message includes a SIB 1 or a MIB.

In another possible implementation, the first indication information indicates location information of a third communication device, where the third communication device is used for communicating between the first communication device and the second communication device. Alternatively,
the first indication information indicates to the first communication device whether to communicate, by using the tone reservation pattern, the data signal carried in each of a plurality of beams, where the plurality of beams include the first beam.

In the foregoing implementation, several possible indication manners in which the first indication information indicates whether to communicate the data signal by using the tone reservation pattern are shown. This helps the first communication device determine, in a specific scenario, whether the data signal needs to be communicated by using the tone reservation pattern, to improve the communication transmission performance. For example, the third communication device is a satellite. When an orbit height of the satellite is large, the first communication device may communicate the data signal by using the tone reservation pattern, to increase a signal-to-noise ratio of a signal received by the second communication device. For example, the first communication device accesses a satellite communication system, and the first communication device performs data transmission through the first beam. Therefore, the first communication device may determine, based on the first indication information, whether to communicate the data signal by using the tone reservation pattern.

In another possible implementation, if the first communication device and the second communication device switch from the first bandwidth part to a second bandwidth part, the method further includes:

The second communication device determines a second tone reservation pattern based on the second bandwidth part. The second communication device communicates the data signal based on the second tone reservation pattern.

In the foregoing implementation, the second communication device switches the bandwidth part. The second communication device may update the tone reservation pattern based on the second bandwidth part to which the second communication device switches. In this way, an updated tone reservation pattern is more suitable for the first communication device and the second communication device. The second communication device communicates the data signal based on the updated tone reservation pattern, to better suppress the PARA of the signal.

In another possible implementation, if the first communication device and the second communication device switch from the first beam to a second beam, the method further includes:

The second communication device correspondingly determines a third tone reservation pattern based on the second beam. The second communication device communicates the data signal based on the second tone reservation pattern.

In the foregoing implementation, the second communication device switches the beam. The second communication device may update the tone reservation pattern based on the second beam to which the second communication device switches. In this way, the updated tone reservation pattern is more suitable for the first communication device and the second communication device. The second communication device communicates the data signal based on the updated tone reservation pattern, to better suppress the PARA of the signal.

In another possible implementation, the first beam corresponds to the first bandwidth part and a third bandwidth part, the first bandwidth part corresponds to the first tone reservation pattern, and the third bandwidth part corresponds to a fourth tone reservation pattern. If the first communication device and the second communication device switch, on the first beam, from the first bandwidth part to the third bandwidth part, the method further includes:

The second communication device determines the fourth tone reservation pattern based on the third bandwidth part. The second communication device communicates the data signal based on the fourth tone reservation pattern.

In the foregoing implementation, the second communication device switches the bandwidth part on the first beam. The second communication device may update the tone reservation pattern based on the second bandwidth part to which the second communication device switches on the first beam. In this way, the updated tone reservation pattern is more suitable for the first communication device and the second communication device. The second communication device communicates the data signal based on the updated tone reservation pattern, to better suppress the PARA of the signal.

In another possible implementation, if on a same time domain resource, a reserved carrier in the first tone reservation pattern overlaps a carrier that is on the first communication device and that is used for communicating the reference signal, the communicating, by the second communication device, a data signal by using the first tone reservation pattern includes: The second communication device punctures an overlapping reserved carrier in the first tone reservation pattern to obtain a fifth tone reservation pattern, where the overlapping reserved carrier is a reserved carrier that is in the first tone reservation pattern and that overlaps the carrier used for communicating the reference signal. The second communication device communicates the data signal based on the fifth tone reservation pattern.

It can be learned that the second communication device punctures the first tone reservation pattern, and then communicates the data signal by using the fifth tone reservation pattern obtained through puncturing. In other words, this application provides a new rule for using the tone reservation pattern, and the tone reservation pattern has a puncturing feature. The second communication device does not need to store or configure a plurality of sets of tone reservation patterns, to reduce storage overheads of the second communication device.

In another possible implementation, the method further includes:

The second communication device sends second configuration information to the first communication device, where the second configuration information includes at least one of the following configuration parameters: a plurality of tone reservation patterns, indexes of the plurality of tone reservation patterns, a mapping relationship between a tone reservation pattern and a reference signal pattern when the first communication device and the second communication use each of a plurality of bandwidth parts, a mapping relationship between a tone reservation pattern and a bandwidth part, a mapping relationship between a tone reservation pattern and a beam, and a mapping relationship between a tone reservation pattern and plurality of bandwidth parts corresponding to the beam.

In the foregoing implementation, the second communication device sends the second configuration information to the first communication device, so that the first communication device determines the configuration parameter included in the second configuration information. The first communication device may determine the first tone reservation pattern based on a mapping relationship included in the second configuration information, and communicate the data signal by using the first tone reservation pattern. In this way, the communication transmission performance is improved.

In another possible implementation, any one of the configuration parameters included in the second configuration information is carried in any one of the following signaling: the SIB 1, the MIB, RRC signaling, DCI, group DCI, a MAC CE, or a TAC.

A third aspect of embodiments of this application provides a first communication device. The first communication device includes:

A processing module is configured to determine a first tone reservation pattern.

A transceiver module is configured to communicate a data signal by using the first tone reservation pattern. The first tone reservation pattern is determined based on a first bandwidth part, or the first tone reservation pattern is determined based on a first beam. The first bandwidth part is used for communicating the data signal between the first communication device and a second communication device, and the first beam is used for communicating the data signal between the first communication device and the second communication device.

In a possible implementation, the processing module is specifically configured to:
obtain first configuration information, where the first configuration information indicates the first tone reservation pattern corresponding to the first bandwidth part; and
determine the first tone reservation pattern based on the first configuration information.

In another possible implementation, the processing module is specifically configured to:
determine, from a plurality of tone reservation patterns based on a first mapping relationship, the first tone reservation pattern corresponding to the first bandwidth part, where the first mapping relationship is a mapping relationship between a tone reservation pattern and a bandwidth part.

In another possible implementation, the processing module is specifically configured to:
determine, from a plurality of tone reservation patterns based on a second mapping relationship, the first tone reservation pattern corresponding to the first beam, where the second mapping relationship is a mapping relationship between a tone reservation pattern and a beam.

In another possible implementation, the processing module is specifically configured to:
determine, from a plurality of tone reservation patterns based on a third mapping relationship, the first tone reservation pattern corresponding to the first bandwidth part, where the third mapping relationship includes a mapping relationship between a tone reservation pattern and a plurality of bandwidth parts corresponding to each of a plurality of beams.

In another possible implementation, the processing module is specifically configured to:
determine, from a plurality of tone reservation patterns based on a fourth mapping relationship and the first bandwidth part, a tone reservation pattern corresponding to a first reference signal pattern, where the fourth mapping relationship is a mapping relationship that is between a tone reservation pattern and a reference signal pattern and that is used when the first communication device and the second communication device use each of a plurality of bandwidth parts.

In another possible implementation, the processing module is further configured to:
determine whether to communicate the data signal by using the tone reservation pattern; and
if the processing module determines to communicate the data signal by using the tone reservation pattern, the step in which the processing module determines the first tone reservation pattern is performed.

In another possible implementation, the processing module is specifically configured to:
obtain first indication information; and
determine, based on the first indication information, whether to communicate the data signal by using the tone reservation pattern.

In another possible implementation, the first indication information is carried in a broadcast message.

In another possible implementation, the broadcast message includes a SIB 1 or a MIB.

In another possible implementation, the first indication information indicates location information of a third communication device, where the third communication device is used for communicating between the first communication device and the second communication device.

The processing module is specifically configured to:
determine, based on the location information of the third communication device, whether to communicate the data signal by using the tone reservation pattern.

In another possible implementation, the first indication information indicates to the first communication device whether to communicate, by using the tone reservation pattern, a data signal carried in each of a plurality of beams, where the plurality of beams include the first beam.

In another possible implementation, if the first communication device and the second communication device switch from the first bandwidth part to a second bandwidth part, the processing module is further configured to:
determine a second tone reservation pattern based on the second bandwidth part.

The transceiver module is further configured to:
communicate the data signal based on the second tone reservation pattern.

In another possible implementation, if the first communication device and the second communication device switch from the first beam to a second beam, the processing module is further configured to:
correspondingly determine a third tone reservation pattern based on the second beam.

The transceiver module is further configured to:
communicate the data signal based on the second tone reservation pattern.

In another possible implementation, the first beam corresponds to the first bandwidth part and a third bandwidth part, the first bandwidth part corresponds to the first tone reservation pattern, and the third bandwidth part corresponds to a fourth tone reservation pattern. If the first communication device and the second communication device switch, on the first beam, from the first bandwidth part to the third bandwidth part, the processing module is further configured to:
determine the fourth tone reservation pattern based on the third bandwidth part.

The transceiver module is further configured to:
communicate the data signal based on the fourth tone reservation pattern.

In another possible implementation, if on a same time domain resource, a reserved carrier in the first tone reservation pattern overlaps a carrier that is on the first communication device and that is used for communicating a reference signal, the transceiver module is specifically configured to:
puncture an overlapping reserved carrier in the first tone reservation pattern to obtain a fifth tone reservation pattern, where the overlapping reserved carrier is a reserved carrier that is in the first tone reservation pattern and that overlaps the carrier used for communicating the reference signal.
communicate the data signal based on the fifth tone reservation pattern.

In another possible implementation, the transceiver module is further configured to:
obtain second configuration information, where the second configuration information includes at least one of the following configuration parameters: a plurality of tone reservation patterns, indexes of the plurality of tone reservation patterns, a mapping relationship between the tone reservation pattern and the reference signal pattern when the first communication device and the second communication device use each of the plurality of bandwidth parts, the mapping relationship between the tone reservation pattern and the bandwidth part, the mapping relationship between the tone reservation pattern and the beam, and the mapping relationship between the tone reservation pattern and the plurality of bandwidth parts corresponding to the beam.

In another possible implementation, any one of the configuration parameters included in the second configuration information is carried in any one of the following signaling: the SIB 1, the MIB, RRC signaling, DCI, group DCI, a MAC CE, or a TAC.

A fourth aspect of embodiments of this application provides a second communication device, including:

A processing module is configured to determine a first tone reservation pattern.

A transceiver module is configured to communicate a data signal by using the first tone reservation pattern. The first tone reservation pattern is determined based on a first bandwidth part, or the first tone reservation pattern is determined based on a first beam. The first bandwidth part is used for communicating the data signal between a first communication device and the second communication device, and the first beam is used for communicating the data signal between the first communication device and the second communication device.

In a possible implementation, the processing module is specifically configured to:
determine, from a plurality of tone reservation patterns based on a first mapping relationship, the first tone reservation pattern corresponding to the first bandwidth part, where the first mapping relationship is a mapping relationship between a tone reservation pattern and a bandwidth part.

In another possible implementation, the processing module is specifically configured to:
determine, from a plurality of tone reservation patterns based on a second mapping relationship, the first tone reservation pattern corresponding to the first beam, where the second mapping relationship is a mapping relationship between a tone reservation pattern and a beam.

In another possible implementation, the processing module is specifically configured to:
determine, from the plurality of tone reservation patterns based on a third mapping relationship, the first tone reservation pattern corresponding to the first bandwidth part, where the third mapping relationship includes a mapping relationship between a tone reservation pattern and a plurality of bandwidth parts corresponding to each of a plurality of beams.

In another possible implementation, a reference signal is communicated between the first communication device and the second communication device by using a first reference signal pattern. The processing module is specifically configured to:
determine, from the plurality of tone reservation patterns based on a fourth mapping relationship and the first bandwidth part, the tone reservation pattern corresponding to the first reference signal pattern, where the fourth mapping relationship is a mapping relationship that is between the tone reservation pattern and a reference signal pattern and that is used when the first communication device and the second communication device use each of a plurality of bandwidth parts.

In another possible implementation, the transceiver module is further configured to:
send first configuration information to the first communication device, where the first configuration information indicates the first tone reservation pattern corresponding to the first bandwidth part.

In another possible implementation, the transceiver module is further configured to:
send first indication information to the first communication device, where the first indication information indicates whether to communicate the data signal by using a tone reservation pattern.

In another possible implementation, the first indication information is carried in a broadcast message.

In another possible implementation, the first indication information indicates location information of a third communication device, where the third communication device is used for communicating between the first communication device and the second communication device. Alternatively,
the first indication information indicates to the first communication device whether to communicate, by using the tone reservation pattern, the data signal carried in each of a plurality of beams, where the plurality of beams include the first beam.

In another possible implementation, if the first communication device and the second communication device switch from the first bandwidth part to a second bandwidth part, the processing module is further configured to:
determine a second tone reservation pattern based on the second bandwidth part.

The transceiver module is further configured to:
communicate the data signal based on the second tone reservation pattern.

In another possible implementation, if the first communication device and the second communication device switch from the first beam to a second beam, the processing module is further configured to:
correspondingly determine a third tone reservation pattern based on the second beam.

The transceiver module is further configured to:
communicate the data signal based on the second tone reservation pattern.

In another possible implementation, the first beam corresponds to the first bandwidth part and a third bandwidth part, the first bandwidth part corresponds to the first tone reservation pattern, and the third bandwidth part corresponds to a fourth tone reservation pattern. If the first communication device and the second communication device switch, on the first beam, from the first bandwidth part to the third bandwidth part, the processing module is further configured to:
determine the fourth tone reservation pattern based on the third bandwidth part.

The transceiver module is further configured to:
communicate the data signal based on the fourth tone reservation pattern.

In another possible implementation, if on a same time domain resource, a reserved carrier in the first tone reservation pattern overlaps a carrier that is on the first communication device and that is used for communicating a reference signal, the processing module is specifically configured to:
puncture an overlapping reserved carrier in the first tone reservation pattern to obtain a fifth tone reservation pattern, where the overlapping reserved carrier is a reserved carrier that is in the first tone reservation pattern and that overlaps the carrier used for communicating the reference signal.

The transceiver module is further configured to:
communicate the data signal based on a fifth tone reservation pattern.

In another possible implementation, the transceiver module is further configured to:
send second configuration information to the first communication device, where the second configuration information includes at least one of the following configuration parameters: a plurality of tone reservation patterns, indexes of the plurality of tone reservation patterns, a mapping relationship between the tone reservation pattern and a reference signal pattern when the first communication device and the second communication device use each of a plurality of bandwidth parts, a mapping relationship between the tone reservation pattern and a bandwidth part, a mapping relationship between the tone reservation pattern and a beam, and a mapping relationship between the tone reservation pattern and the plurality of bandwidth parts corresponding to the beam.

In another possible implementation, any one of the configuration parameters included in the second configuration information is carried in any one of the following signaling: a SIB 1, a MIB, RRC signaling, DCI, group DCI, a MAC CE, or a TAC.

A fifth aspect of embodiments of this application provides a first communication device. The first communication device includes a processor and a memory. The memory stores a computer program. The processor is configured to invoke and run the computer program stored in the memory, so that the processor implements any one of the implementations of the first aspect.

Optionally, the first communication device further includes a transceiver. The processor is further configured to control the transceiver to receive/send a signal.

A sixth aspect of embodiments of this application provides a second communication device. The second communication device includes a processor and a memory. The memory stores a computer program. The processor is configured to invoke and run the computer program stored in the memory, so that the processor implements any one of the implementations of the second aspect.

Optionally, the second communication device further includes a transceiver. The processor is further configured to control the transceiver to receive/send a signal.

A seventh aspect of embodiments of this application provides a first communication device. The first communication device includes a logic circuit and an input/output interface. The logic circuit is configured to perform a processing operation in any one of the implementations of the first aspect, and the input/output interface is configured to perform a sending/receiving operation in any one of the implementations of the first aspect.

An eighth aspect of embodiments of this application provides a second communication device. The second communication device includes a logic circuit and an input/output interface. The logic circuit is configured to perform a processing operation in any one of the implementations of the second aspect, and the input/output interface is configured to perform a sending/receiving operation in any one of the implementations of the second aspect.

A ninth aspect of embodiments of this application provides a computer program product including instructions. When the computer program product runs on a computer, the computer is enabled to perform any one of the implementations of the first aspect and the second aspect.

A tenth aspect of embodiments of this application provides a computer-readable storage medium, including computer instructions. When the computer instructions are run on a computer, the computer is enabled to perform any one of the implementations of the first aspect and the second aspect.

An eleventh aspect of embodiments of this application provides a chip apparatus, including a processor. The processing is configured to be connected to a memory and invoke a program stored in the memory, to enable the processor to perform any one of the implementations of the first aspect to the second aspect.

A twelfth aspect of embodiments of this application provides a communication system. The communication system includes the first communication device in the third aspect and the second communication device in the fourth aspect.

According to the foregoing technical solutions, it can be learned that embodiments of this application have the following advantages.

It can be learned from the foregoing technical solutions that the first communication device determines the first tone reservation pattern, and the first communication device communicates the data signal by using the first tone pattern. The first tone reservation pattern is determined based on the first bandwidth part, or the first tone reservation pattern is determined based on the first beam. The first bandwidth part is used for communicating the data signal between the first communication device and the second communication device, and the first beam is used for communicating the data signal between the first communication device and the second communication device. It can be learned that the first tone reservation pattern is determined based on the first bandwidth part, or the first tone reservation pattern is determined based on the first beam. The first tone pattern is more suitable for the first communication device and the second communication device. The first communication device may communicate the data signal by using the first tone reservation pattern to suppress the PARA of the signal and improve the communication transmission performance.

### BRIEF DESCRIPTION OF DRAWINGS

FIG. 1A is a schematic diagram of a communication system according to an embodiment of this application;

FIG. 1B is another schematic diagram of a communication system according to an embodiment of this application;

FIG. 1C is another schematic diagram of a communication system according to an embodiment of this application;

FIG. 1D is another schematic diagram of a communication system according to an embodiment of this application;

FIG. 2 is a schematic diagram of an embodiment of a communication processing method according to an embodiment of this application;

FIG. 3 is a schematic diagram of a scenario of a communication processing method according to an embodiment of this application;

FIG. 4 is a schematic diagram of another embodiment of a communication processing method according to an embodiment of this application;

FIG. 5 is a schematic diagram of another embodiment of a communication processing method according to an embodiment of this application;

FIG. 6 is a schematic diagram of another embodiment of a communication processing method according to an embodiment of this application;

FIG. 7 is a schematic diagram of another scenario of a communication processing method according to an embodiment of this application;

FIG. 8 is a schematic diagram of another embodiment of a communication processing method according to an embodiment of this application;

FIG. 9 is a schematic diagram of another scenario of a communication processing method according to an embodiment of this application;

FIG. 10 is a schematic diagram of another embodiment of a communication processing method according to an embodiment of this application;

FIG. 11 is a schematic diagram of a tone reservation pattern, a demodulation reference signal (demodulation reference signal, DMRS) pattern, and a tone reservation pattern obtained through puncturing according to an embodiment of this application;

FIG. 12 is a schematic diagram of a tone reservation pattern, a phase-tracking reference signal (phase-tracking reference signal, PTRS) pattern, and a tone reservation pattern obtained through puncturing according to an embodiment of this application;

FIG. 13 is a schematic diagram of another embodiment of a communication processing method according to an embodiment of this application;

FIG. 14 is a schematic diagram of a structure of a first communication device according to an embodiment of this application;

FIG. 15 is a schematic diagram of a structure of a second communication device according to an embodiment of this application;

FIG. 16 is a schematic diagram of a structure of a terminal device according to an embodiment of this application;

FIG. 17 is a schematic diagram of another structure of a second communication device according to an embodiment of this application;

FIG. 18 is a schematic diagram of another structure of a first communication device according to an embodiment of this application;

FIG. 19 is a schematic diagram of another structure of a second communication device according to an embodiment of this application; and

FIG. 20 is a schematic diagram of a communication system according to an embodiment of this application.

### DESCRIPTION OF EMBODIMENTS

Embodiments of this application provide a communication processing method and a communication processing apparatus, to suppress PARA of a signal and improve communication transmission performance.

Reference to “an embodiment”, “some embodiments”, or the like described in this specification indicates that one or more embodiments of this application include a specific feature, structure, or characteristic described with reference to embodiments. Therefore, statements, for example, “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. The terms “comprise”, “include”, “have”, and variants thereof all mean “include but are not limited to”, unless otherwise specifically emphasized in another manner.

In this application, “at least one” means one or more, and “a plurality of” means two or more than two. “And/or” describes an association relationship between associated objects, and represents that three relationships may exist. For example, A and/or B may represent: Only A exists, both A and B exist, and only B exists, where A and B each may be singular or plural. “At least one of the following items (pieces)” or a similar expression thereof refers to any combination of these items, including any combination of singular items (pieces) or plural items (pieces). For example, at least one item (piece) of a, b, or c may represent a, b, c, a-b, a-c, b-c, or a-b-c, where a, b, and c each may be singular or plural.

The technical solutions of this application may be applied to a terrestrial network system, or may be applied to a non-terrestrial network (non-terrestrial network, NTN) system.

The ground network system may include a cellular communication system, an internet of things communication system, an internet of vehicles communication system, a device-to-device (device to device, D2D) communication system, a mobile communication system, and the like. The mobile communication system may be a fourth generation (4^{th} generation, 4G) communication system, a worldwide interoperability for microwave access (worldwide interoperability for microwave access, WiMAX) communication system, a fifth generation (5^{th} generation, 5G) communication system, a future mobile communication system, or the like. For example, the 4G communication system may be a long term evolution (long term evolution, LTE) system, and the 5G communication system may be a new radio (new radio, NR) system.

The non-terrestrial network system may include a satellite communication system and a high altitude platform (high altitude platform station, HAPS) communication system, for example, an integrated communication and navigation (integrated communication and navigation, ICAN) system, a global navigation satellite system (global navigation satellite system, GNSS), and an ultra-dense low-orbit satellite communication system. The satellite communication system may be integrated with a conventional mobile communication system.

A communication system to which embodiments of this application are applicable includes a first communication device and a second communication device. The second communication device supports access of the first communication device, to implement communication transmission between the first communication device and the second communication device. The first communication device may be a terminal device, and the second communication device may be a network device. Alternatively, both the first communication device and the second communication device are terminal devices. The following describes the technical solutions of this application by using an example in which the first communication device may be a terminal device and the second communication device may be a network device.

The first communication device may be the terminal device. The terminal device may be a device that provides voice or data connectivity for a user. The terminal device is also referred to as user equipment (user equipment, UE), or may be referred to as a mobile station (mobile station), a subscriber unit (subscriber unit), a station (station), a terminal equipment (terminal equipment, TE), or the like. The terminal device may be a cellular phone (phone), a personal digital assistant (personal digital assistant, PDA), a wireless modem (modem), a handheld (handheld) device, a laptop computer (laptop computer), a cordless phone (cordless phone), a wireless local loop (wireless local loop, WLL), a tablet computer (pad), an-vehicle device, a vehicle module, a vehicle, a wearable device, a computing device, an airplane, an uncrewed aerial vehicle, or the like. With development of wireless communication technologies, any device that can access a communication system, can communicate with a network side in a communication system, or can communicate with another object through a communication system may be the terminal device in embodiments of this application. For example, the device may be a terminal device and a vehicle in intelligent transportation, a household device in a smart household, an electricity meter reading instrument in a smart grid, a voltage monitoring instrument, an environment monitoring instrument, a video surveillance instrument in an intelligent security network, or a cashing machine.

The second communication device may be the network device. The second communication device supports functions, for example, access of the terminal device and provides a communication service for the terminal device. For example, the second communication device may be a terrestrial device, for example, an evolved NodeB (evolved NodeB, eNB) in a 4G access technology communication system, a next generation NodeB (next generation NodeB, gNB) in a 5G access technology communication system, a transmission reception point (transmission reception point, TRP), a relay node (relay node), or an access point (access point, AP). Alternatively, the first communication device may be a non-ground device: a high-altitude base station, for example, may be a device, for example, a hot air balloon that can provide a wireless access function for a terminal device, a low-orbit satellite, a medium-orbit satellite, or a high-orbit satellite, may be an uncrewed aerial vehicle, or may be a mobile switching center or a device that functions as a base station in device-to-device (Device-to-Device, D2D) communication, vehicle-to-everything (vehicle-to-everything, V2X) communication, or machine-to-machine (machine-to-machine, M2M) communication.

The following describes terms used in this application.

A tone reservation pattern includes a reserved carrier in carriers included in one bandwidth part and/or a reserved carrier in carriers included outside the bandwidth part. The reserved carrier is used for communicating a kernel (TR kernel) signal to suppress PARA of the signal. The following uses an example in which the tone reservation pattern includes the reserved carrier in the carriers included in the bandwidth part for description.

For example, a transmitting device sends the tone reservation kernel signal to a receiving device on the reserved carrier in the bandwidth part to suppress the PARA of the signal. The transmitting device sends a data signal on a carrier other than the reserved carrier in the bandwidth part. The receiving device receives the kernel signal on the reserved carrier. The receiving device receives the data signal from the transmitting device on the carrier other than the reserved carrier in the bandwidth part based on resource scheduling on a network side.

After converting the received signal to frequency domain, the receiving device skips data on the reserved carrier included in the tone reservation pattern when selecting data on a corresponding carrier. In other words, the receiving device does not decode the data on the reserved carrier included in the tone reservation pattern. In this application, if the transmitting device is a first communication device, the receiving device is a second communication device; or if the transmitting device is a second communication device, the receiving device is a first communication device. It should be noted that, if the tone reservation pattern includes the reserved carrier in the carriers included outside the bandwidth part, the receiving device may not receive a signal on the reserved carrier, in other words, the receiving device does not monitor a channel on the reserved carrier.

The reserved carrier in the tone reservation pattern may be represented by a carrier number of the reserved carrier. The carrier number included in the tone reservation pattern indicates that a carrier corresponding to the carrier number is the reserved carrier, namely, a carrier occupied by the kernel signal. In the following, carriers included in one bandwidth part are numbered from 1. To be specific, in the carriers included in the bandwidth part, a carrier number of the 1^{st} carrier is 1, a carrier number of the 2^{nd} carrier is 2, and so on.

For example, 2048 carriers are included in one bandwidth part, and the tone reservation pattern is {2 3 13 19 20 29 39 40 44 45 49 69 79 89 94 105 136 141 157 213 220 246 293 912 919 961}. To be specific, in the 2048 carriers included in the bandwidth part, the 2 nd carrier, the 3^{rd} d carrier, the 13^{th} carrier, the 19^{th} carrier, the 20^{th} carrier, the 29^{th} carrier, the 39^{th} carrier, the 40^{th} carrier, the 44^{th} carrier, the 45^{th} carrier, the 49^{th} carrier, the 69^{th} carrier, the 79^{th} carrier, the 89^{th} carrier, the 94^{th} carrier, the 105^{th} carrier, the 136^{th} carrier, the 141^{st} carrier, the 157^{th} carrier, the 213^{th} carrier, the 220^{th} carrier, the 246^{th} carrier, the 293^{rd} carrier, the 912^{th} carrier, the 919^{th} carrier, and the 961^{st} carrier are reserved carriers.

During actual application, carrier numbers of carriers included in one bandwidth part are not limited in this application. For example, in this application, the carriers included in the bandwidth part may be numbered from 0. For example, if the carrier numbers start from 0, carrier numbers included in a tone reservation pattern shown in the following each only need to be subtracted by 1.

In this application, different beams may be distinguished in a communication standard protocol based on bandwidth parts, transmission configuration indicators (transmission configuration indicators, TCIs), or synchronization signal blocks (synchronization signal blocks, SSBs). In other words, a beam may be indicated based on a bandwidth part, a TCI, or an SSB. Therefore, beam switching may be indicated between a terminal device and a network device by switching the bandwidth part, the TCI, or the SSB. Therefore, for the terminal device and/or the network device, an operation actually performed for beam switching may be switching of the bandwidth part, the TCI, or the SSB.

In this application, the beam may be replaced with the bandwidth part, the TCI, or the SSB. Therefore, in other words, the first communication device or the second communication device may complete determining of the tone reservation pattern in a scenario of bandwidth part switching, TCI switching, or SSB switching according to the method provided in this application. For example, in this application, a beam used by the terminal device to currently access the network device may be replaced with a bandwidth part, a TCI, or an SSB used by the terminal device to currently access the network device.

In this application, optionally, a carrier may be a subcarrier. This is not specifically limited in this application.

The following describes some application scenarios to which this application is applicable.

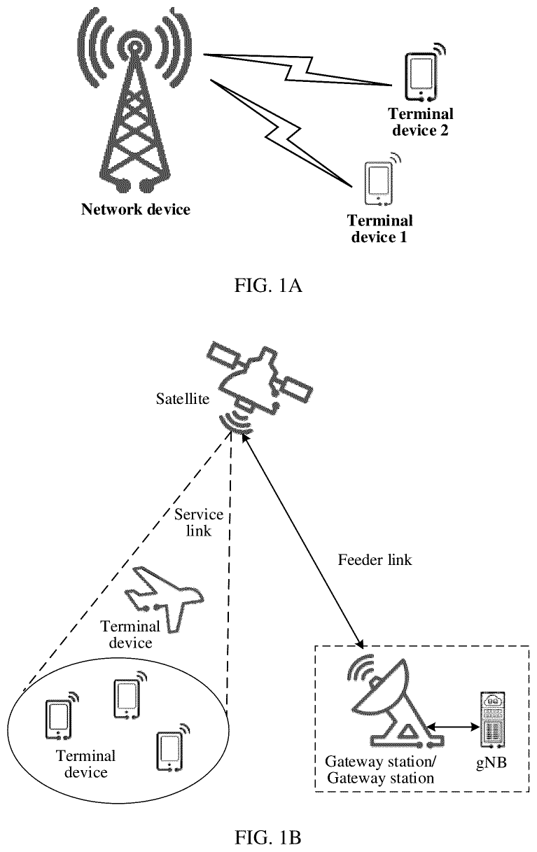

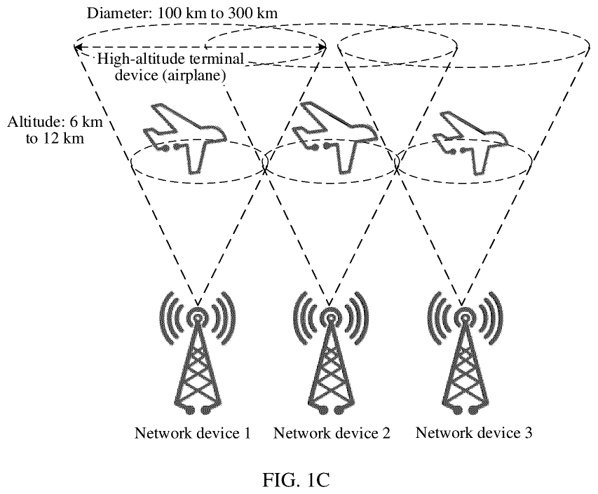

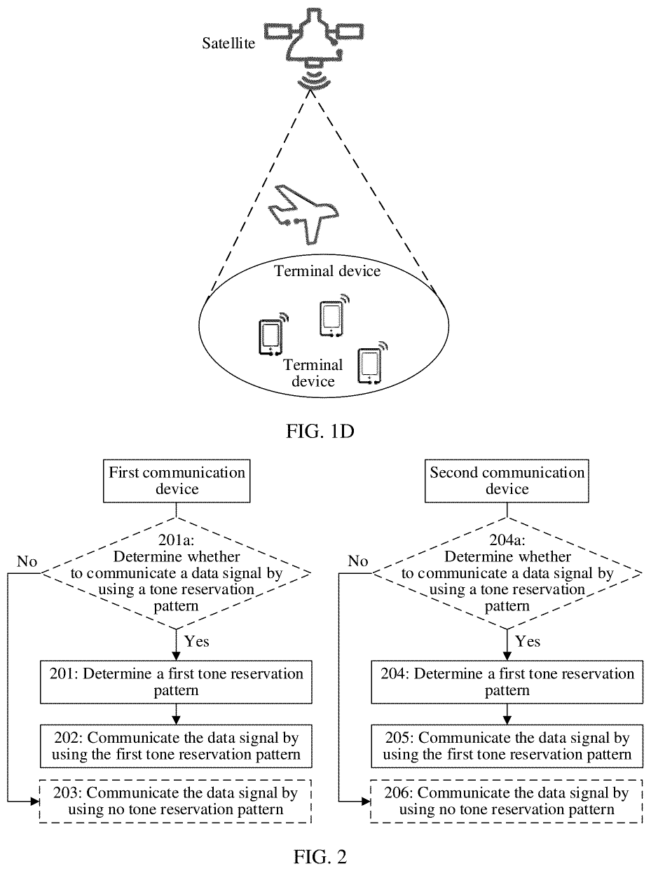

FIG. 1A is a schematic diagram of a communication system according to an embodiment of this application. Refer to FIG. 1A. The communication system shown in FIG. 1A includes a network device and a terminal device. The network device and the terminal device may perform communication transmission by using a tone reservation pattern. The transmission may include uplink transmission and downlink transmission.

A first communication device may be understood as the terminal device shown in FIG. 1A, and a second communication device may be understood as the network device shown in FIG. 1A.

FIG. 1B is another schematic diagram of a communication system according to an embodiment of this application. Refer to FIG. 1B. The communication system shown in FIG. 1B includes a terminal device, a satellite, a gNB, and a gateway station (which is also referred to as a gateway station). The terminal device may include user equipment, an airplane, and the like. A base station and the terminal device perform communication transmission through the satellite and the gateway station. The gNB and the terminal device may perform communication transmission by using a tone reservation pattern. The communication transmission may include uplink transmission and downlink transmission.

A first communication device may be understood as the terminal device shown in FIG. 1B, and a second communication device may be understood as the gNB shown in FIG. 1B.

FIG. 1C is another schematic diagram of a communication system according to an embodiment of this application. Refer to FIG. 1C. The communication system shown in FIG. 1C includes a high-altitude terminal device (for example, an airplane or an uncrewed aerial vehicle) and a network device. The high-altitude terminal device and the network device may perform communication transmission by using a tone reservation pattern. The communication transmission may include uplink transmission and downlink transmission.

A first communication device may be understood as the high-altitude terminal device shown in FIG. 1C, and a second communication device may be understood as the network device shown in FIG. 1C.

FIG. 1D is another schematic diagram of a communication system according to an embodiment of this application. Refer to FIG. 1D. The communication system shown in FIG. 1D includes a terminal device and a satellite. The terminal device may include a user terminal, an airplane, and the like. The satellite has a function of a network device, and can provide an access service and a communication service for the terminal device. For example, the terminal device and the satellite perform communication transmission. The communication transmission may include uplink transmission and downlink transmission.

A first communication device may be understood as the terminal device shown in FIG. 1D, and a second communication device may be understood as the satellite shown in FIG. 1D.

The following describes the technical solutions of this application with reference to specific embodiments.

FIG. 2 is a schematic diagram of an embodiment of a communication processing method according to an embodiment of this application. Refer to FIG. 2. The communication processing method includes the following steps.
201: A first communication device determines a first tone reservation pattern (TR pattern).

The first tone reservation pattern is determined based on a first bandwidth part (bandwidth part, BWP), or the first tone reservation pattern is determined based on a first beam. The first bandwidth part is used for communicating a data signal between the first communication device and a second communication device. The first beam is used for communicating the data signal between the first communication device and the second communication device.

For example, the first communication device is a terminal device, and the second communication device is a network device. The first tone reservation pattern may be a tone reservation pattern corresponding to the first bandwidth part, or the first tone reservation pattern may be a tone reservation pattern corresponding to the first beam. Therefore, the first tone pattern is more suitable for the terminal device.

For a determining manner in which the first communication device determines the first tone reservation pattern, refer to the following related descriptions. Details are not described herein. Optionally, the embodiment shown in FIG. 2 further includes step 201a. Step 201a may be performed before step 201.
201a: The first communication device determines whether to communicate the data signal by using the tone reservation pattern, and if the first communication device determines to communicate the data signal by using the tone reservation pattern, step 201 is performed; or if the first communication device determines to communicate the data signal by using no tone reservation pattern, step 203 is performed.

In step 201a, there are a plurality of manners in which the first communication device determines whether to communicate the data signal by using the tone reservation pattern. For a specific determining manner, refer to the following related descriptions. Details are not described herein.
202: The first communication device communicates the data signal by using the first tone reservation pattern.

In a possible implementation, the first communication device receives the data signal by using the first tone reservation pattern.

For example, the first communication device is the terminal device, and the second communication device is the network device. The second communication device sends a downlink data signal to the first communication device by using the first tone reservation pattern. The first communication device receives the downlink data signal from the second communication device by using the first tone reservation pattern.

In some implementation manners, the first communication device is the terminal device. The terminal device is in an idle (idle) state, and performs step 201 and step 202. In other words, the terminal device may perform data transmission by using the first tone reservation pattern in an initial access process, to improve communication transmission performance.

In some implementation manners, the first communication device is the terminal device. The terminal device is in an inactive (inactive) state or a connected (connected) state, and performs step 201 and step 202. For example, the first tone reservation pattern is the tone reservation pattern corresponding to the first bandwidth part or the first beam. The first tone pattern is more suitable for the terminal device. The terminal device may communicate the data signal by using the first tone reservation pattern to suppress PARA of the signal and improve the communication transmission performance.

In another possible implementation, the first communication device sends the data signal by using the first tone reservation pattern.

For example, the first communication device is the terminal device, and the second communication device is the network device. The first communication device sends an uplink data signal to the second communication device by using the first tone reservation pattern. The second communication device receives, by using the first tone reservation pattern, the uplink data signal sent from the first communication device.
203: The first communication device communicates the data signal by using no tone reservation pattern.

For example, the second communication device sends the downlink data signal to the first communication device by using no tone reservation pattern. The first communication device receives the downlink data signal from the second communication device by using no tone reservation pattern.

For example, the second communication device sends the uplink data signal to the first communication device by using no tone reservation pattern. The first communication device receives the uplink data signal from the second communication device by using no tone reservation pattern.

Correspondingly, operations performed by the second communication device include step 204 and step 205.
204: The second communication device determines the first tone reservation pattern.
205: The second communication device communicates the data signal by using the first tone reservation pattern.

Step 204 and step 205 are similar to step 201 and step 202. For details, refer to the related descriptions of step 201 and step 202. Details are not described herein again.

Optionally, the embodiment shown in FIG. 2 further includes step 204a and step 206. Step 204a is performed before step 204. Step 206 may be performed before step 204a.
204a: The second communication device determines whether to communicate the data signal by using the tone reservation pattern, and if the second communication device determines to communicate the data signal by using the tone reservation pattern, step 204 is performed; or if the second communication device determines to communicate the data signal by using no tone reservation pattern, step 206 is performed.
206: The first communication device communicates the data signal by using no tone reservation pattern.

Step 204a and step 206 are similar to step 201a and step 204. For details, refer to the related descriptions of step 201a and step 204. Details are not described herein again.

In this embodiment of this application, the first communication device determines the first tone reservation pattern. The first communication device communicates the data signal by using the first tone pattern. The first tone reservation pattern is determined based on the first bandwidth part, or the first tone reservation pattern is determined based on the first beam. The first bandwidth part is used for communicating the data signal between the first communication device and the second communication device. The first beam is used for communicating the data signal between the first communication device and the second communication device. It can be learned that the first tone reservation pattern is determined based on the first bandwidth part, or the first tone reservation pattern is determined based on the first beam. The first tone pattern is more suitable for the terminal device. The terminal device communicates the data signal by using the first tone reservation pattern to suppress the PARA of the signal and improve the communication transmission performance.

In step 201 of the embodiment shown in FIG. 2, there are a plurality of manners in which the first communication device determines the first tone reservation pattern. The following shows several possible implementations. This application is still applicable to another implementation. Implementations of the following examples do not limit the technical solutions of this application.

Implementation 1

In step 201 of the embodiment shown in FIG. 2, the first tone reservation pattern is a default tone reservation pattern preconfigured or predefined in the first communication device. For example, the default tone reservation pattern may be defined in a communication protocol. The default tone reservation pattern may be a tone reservation pattern corresponding to an initial bandwidth part (initial BWP). The initial bandwidth part is used by the first communication device to access a network. Step 201 specifically includes: The terminal device determines the default tone reservation pattern.

Optionally, a configuration granularity of the initial bandwidth part may be a cell-level granularity, a UE-level granularity, or a beam-level granularity. This is not specifically limited in this application.

For example, the network device configures a corresponding initial bandwidth part for each cell, and different cells may correspond to different initial bandwidth parts. That is, the configuration granularity of the initial bandwidth part is the cell-level granularity.

For example, the network device configures a corresponding initial bandwidth part for each UE, and different UEs correspond to different initial bandwidth parts. That is, the configuration granularity of the initial bandwidth part is the UE-level granularity.

For example, the network device configures a corresponding initial bandwidth part for each beam, and different beams may correspond to different initial bandwidth parts. That is, the configuration granularity of the initial bandwidth part is the beam-level granularity.

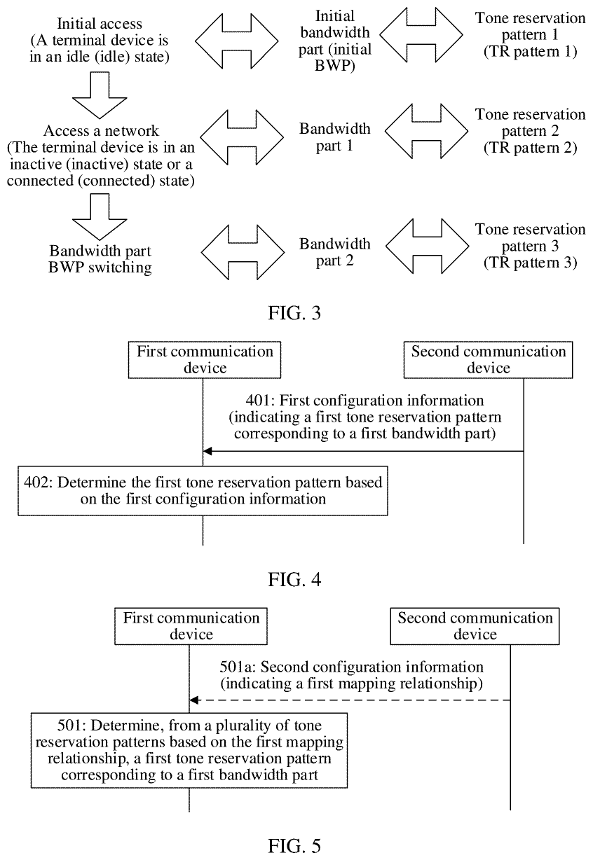

For example, the first communication device is the terminal device, and the terminal device is in the idle state. As shown in FIG. 3, the terminal device uses the initial bandwidth part in the initial access process. The default tone reservation pattern corresponding to the initial bandwidth part is a tone reservation pattern 1 shown in FIG. 3. The terminal device determines the default tone reservation pattern corresponding to the initial bandwidth part. The network device may send the downlink data signal to the terminal device based on the default tone reservation pattern, and correspondingly, the terminal device receives the downlink data signal from the network device based on the default tone reservation pattern. Alternatively, the terminal device may send the uplink data signal to the network device based on the default tone reservation pattern, and correspondingly, the network device receives the uplink data signal from the terminal device based on the default tone reservation pattern.

Implementation 2 The following describes Implementation 2 with reference to an embodiment shown in FIG. 4.

FIG. 4 is a schematic diagram of another embodiment of a communication processing method according to an embodiment of this application. Refer to FIG. 4. The communication processing method includes the following steps.
401: A first communication device receives first configuration information from a second communication device. The first configuration information indicates a first tone reservation pattern corresponding to a first bandwidth part.

Specifically, the first communication device obtains the first configuration information. For example, the second communication device sends the first configuration information to the first communication device. Correspondingly, the first communication device may receive the first configuration information from the second communication device.

In some implementation manners, the first configuration information includes the first tone reservation pattern; or the first configuration information includes an index of the first tone reservation pattern.

For example, the index of the first tone reservation pattern is carried in BWP configuration signaling. The following shows a code format of the BWP configuration signaling. It should be noted that the following code format is merely an example, and does not constitute a limitation on the technical solutions of this application.

```
  -- ASN1START
  -- TAG-BWP-START
```

| | |
|---|---|
| BWP ::= | SEQUENCE { |
| locationAndBandwidth | locationAndBandwidth, |
| subcarrierSpacing | SubcarrierSpacing, |
| cyclicPrefix | ENUMERATED { extended } |

OPTIONAL -- Need R

| | | |
|---|---|---|
| TR-pattern-index | INTEGER | (0..63), |

```
OPTIONAL -- Need R
  }
  -- TAG-BWP-STOP
  -- ASN1STOP
```

TR-pattern-index indicates that a terminal device communicates a data signal by using TR-pattern corresponding to TR-pattern-index when using a bandwidth part indicated by the BWP configuration signaling.

It should be noted that the first communication device may store a plurality of tone reservation patterns, indexes of the plurality of tone reservation patterns, and a mapping relationship between a tone reservation pattern and an index. The first communication device may determine the first tone reservation pattern from the plurality of tone reservation patterns based on the index indicated by the first configuration information.

It should be noted that the plurality of tone reservation patterns, the indexes of the plurality of tone reservation patterns, and the mapping relationship between a tone reservation pattern and an index may be preconfigured, indicated by the second communication device to the first communication device, or predefined (for example, specified in a communication protocol). This is not specifically limited in this application.

The following shows an example of the mapping relationship between a tone reservation pattern and an index by using Table 1.

TABLE 1

| Index (index) of a | |
|---|---|
| tone reservation | |
| pattern | Tone reservation pattern (TR pattern) |
| 0 | 2 3 13 19 20 29 39 40 44 45 49 69 79 89 94 105 136 141 157 213 220 |
| | 246 293 912 919 961 1003 1073 1085 1129 1138 1145 1146 1181 1236 |
| | 1264 1269 1302 1308 1321 1396 1402 1449 1452 1506 1507 1516 1521 |
| | 1532 1533 1537 1549 1550 1557 1564 1575 1583 |
| 1 | 4 10 13 22 28 37 39 58 89 109 123 140 154 161 166 189 190 193 207 |
| | 214 229 290 323 325 327 335 817 911 965 1035 1065 1170 1181 1282 |
| | 1288 1317 1348 1386 1397 1412 1414 1419 1440 1461 1464 1466 1467 |
| | 1469 1512 1534 1541 1543 1544 1550 1551 1553 1568 |
| 2 | 5 6 7 11 29 31 71 79 83 85 99 111 138 161 166 181 183 194 210 240 263 |
| | 272 301 305 800 959 985 988 1001 1160 1203 1225 1244 1265 1298 |
| | 1334 1343 1372 1377 1385 1390 1401 1405 1439 1448 1455 1472 1481 |
| | 1482 1514 1527 1544 1555 1562 1563 1564 1571 |
| 3 | 2 7 8 9 11 15 16 17 18 20 21 22 23 26 28 31 33 36 144 154 156 165 186 |
| | 189 190 206 209 210 223 227 229 230 231 234 238 240 |
| 4 | 2 4 10 12 14 16 18 20 22 24 26 28 34 36 38 126 146 150 152 154 176 |
| | 182 184 186 188 200 204 210 212 214 216 220 226 228 230 232 234 236 |
| | 238 240 |
| 5 | 2 4 6 7 8 10 11 14 16 18 20 28 30 31 32 35 38 40 138 139 154 156 160 |
| | 174 175 195 196 200 211 212 214 216 220 222 223 228 230 232 236 239 |
| 6 | 1 4 5 7 8 9 11 13 16 17 20 28 29 31 32 35 37 40 137 139 153 156 160 |
| | 173 175 195 196 200 211 212 213 216 220 221 223 228 229 232 236 239 |
| . . . | . . . |

For example, if the first configuration information indicates the index 0, it can be learned from Table 1 that the first communication device may determine that the first tone reservation pattern is {2 3 13 19 20 29 39 40 44 45 49 69 79 89 94 105 136 141 157 213 220 246 293 912 919 961 1003 1073 1085 1129 1138 1145 1146 1181 1236 1264 1269 1302 1308 1321 1396 1402 1449 1452 1506 1507 1516 1521 1532 1533 1537 1549 1550 1557 1564 1575 1583}.
402: The first communication device determines the first tone reservation pattern based on the first configuration information.

In a possible implementation, the first configuration information includes the first tone reservation pattern. The first communication device may determine the first tone reservation pattern based on the first configuration information.

In another possible implementation, the first configuration information includes the index of the first tone reservation pattern. The first communication device may determine the first tone reservation pattern from the plurality of tone reservation patterns based on the index of the first tone reservation pattern and the mapping relationship between a tone reservation pattern and an index.

For example, the first configuration information indicates the index 0, and the first communication device may determine, by using Table 1, that the first tone reservation pattern is {2 3 13 19 20 29 39 40 44 45 49 69 79 89 94 105 136 141 157 213 220 246 293 912 919 961 1003 1073 1085 1129 1138 1145 1146 1181 1236 1264 1269 1302 1308 1321 1396 1402 1449 1452 1506 1507 1516 1521 1532 1533 1537 1549 1550 1557 1564 1575 1583}. For example, the first communication device receives, by using the first tone reservation pattern, a data signal sent by the second communication device. Specifically, the first communication device receives a kernel signal from the second communication device on a reserved carrier included in the first tone reservation pattern, and receives a data signal from a transmitting device on a carrier other than the reserved carrier in a bandwidth part based on resource scheduling on a network side. After converting the received signal to frequency domain, the first communication device skips the reserved carrier indicated by the first tone reservation pattern when selecting data on a corresponding carrier. In other words, the second communication device does not perform decoding processing on data on the reserved carrier included in the first tone reservation pattern.

Implementation 3

The following describes Implementation 3 with reference to an embodiment shown in FIG. 5.
501: A first communication device determines, from a plurality of tone patterns based on a first mapping relationship, a first tone reservation pattern corresponding to a first bandwidth part.

The first mapping relationship is a mapping relationship between a tone reservation pattern and a bandwidth part.

Optionally, the first mapping relationship may be preconfigured, indicated by a second communication device to the first communication device, or specified in a communication protocol. This is not specifically limited in this application.

The first communication device stores the plurality of tone reservation patterns. The plurality of tone reservation patterns may be preconfigured, sent by the second communication device to the first communication device, or specified in a communication protocol. This is not specifically limited in this application.

In a possible implementation, the first mapping relationship is a mapping relationship between a tone reservation pattern and an index of a bandwidth part. The first communication device determines, from the plurality of tone patterns based on the first mapping relationship, a first tone reservation pattern corresponding to an index of the first bandwidth part.

For example, the following indicates, by using Table 2, the mapping relationship between a tone reservation pattern and an index of a bandwidth part.

TABLE 2

| Index of a | |
|---|---|
| bandwidth part | |
| BWP | Tone reservation pattern (TR pattern) |
| 0 | 2 3 13 19 20 29 39 40 44 45 49 69 79 89 94 105 136 141 157 213 220 246 |
| | 293 912 919 961 1003 1073 1085 1129 1138 1145 1146 1181 1236 1264 |
| | 1269 1302 1308 1321 1396 1402 1449 1452 1506 1507 1516 1521 1532 |
| | 1533 1537 1549 1550 1557 1564 1575 1583 |
| 1 | 4 10 13 22 28 37 39 58 89 109 123 140 154 161 166 189 190 193 207 214 |
| | 229 290 323 325 327 335 817 911 965 1035 1065 1170 1181 1282 1288 |
| | 1317 1348 1386 1397 1412 1414 1419 1440 1461 1464 1466 1467 1469 |
| | 1512 1534 1541 1543 1544 1550 1551 1553 1568 |
| 2 | 2 7 8 9 11 15 16 17 18 20 21 22 23 26 28 31 33 36 144 154 156 165 186 189 |
| | 190 206 209 210 223 227 229 230 231 234 238 240 |
| 3 | 19 20 35 37 41 55 56 76 77 81 92 93 95 97 101 103 104 109 111 113 117 |
| | 120 906 908 910 911 912 914 915 918 920 922 924 932 934 935 936 939 |
| | 942 944 |

In Table 2, configuration information of the bandwidth part corresponding to the index 0 may include any one of the following: a 200 M bandwidth and a 120 kHz (kilohertz) carrier spacing, a 100 M bandwidth and a 60 kHz carrier spacing, a 50 M bandwidth and a 30 kHz carrier spacing, or a 25 M bandwidth and a 15 kHz carrier spacing. Configuration information of the bandwidth part corresponding to the index 1 may be any one of the following: a 200 M (mega) bandwidth and a 120 kHz carrier spacing, a 100 M bandwidth and a 60 kHz carrier spacing, a 50 M bandwidth and a 30 kHz carrier spacing, or a 25 M bandwidth and a 15 kHz carrier spacing.

Configuration information of the bandwidth part corresponding to the index 2 may include any one of the following: a 30 M bandwidth and a 120 kHz carrier spacing, a 15 M bandwidth and a 60 kHz carrier spacing, a 7.5 M bandwidth and a 30 kHz carrier spacing, or a 3.75 M bandwidth and a 15 kHz carrier spacing. Configuration information of the bandwidth part corresponding to the index 3 may include any one of the following: a 30 M bandwidth and a 120 kHz carrier spacing, a 15 M bandwidth and a 60 kHz carrier spacing, a 7.5 M bandwidth and a 30 kHz carrier spacing, or a 3.75 M bandwidth and a 15 kHz carrier spacing.

For example, if the index of the first bandwidth part is 0, the first communication device may determine, by using Table 2, that the first tone reservation pattern corresponding to the index 0 is {2 3 13 19 20 29 39 40 44 45 49 69 79 89 94 105 136 141 157 213 220 246 293 912 919 961 1003 1073 1085 1129 1138 1145 1146 1181 1236 1264 1269 1302 1308 1321 1396 1402 1449 1452 1506 1507 1516 1521 1532 1533 1537 1549 1550 1557 1564 1575 1583}. For example, the first communication device receives, by using the first tone reservation pattern, a data signal sent by the second communication device. Specifically, the first communication device receives a kernel signal from the second communication device on a reserved carrier included in the first tone reservation pattern, and receives a data signal from a transmitting device on a carrier other than the reserved carrier in a bandwidth part based on resource scheduling on a network side. After converting the received signal to frequency domain, the first communication device skips the reserved carrier indicated by the first tone reservation pattern when selecting data on a corresponding carrier. In other words, the first communication device does not perform decoding processing on data on the reserved carrier included in the first tone reservation pattern.

Optionally, for establishment of the mapping relationship between a tone reservation pattern and an index of a bandwidth part, at least one of the following factors may be considered: a bandwidth, a carrier spacing, and a fast Fourier transformation (fast Fourier transformation, FFT) length or an inverse fast Fourier transformation (inverse fast Fourier transformation, IFFT) length of the BWP, and distribution of a reserved carrier included in the tone reservation pattern. Distribution of the reserved carrier included in the tone reservation pattern includes: tone reservation is distributed in the bandwidth part and/or distributed outside the bandwidth part.

For example, the second communication device uses, as considered factors, the bandwidth, the carrier spacing, and the FFT length or the IFFT length of the bandwidth part, and distribution of the reserved carrier included in the tone reservation pattern, and traverses all tone reservation patterns to optimize a suppression effect of PARA of a signal, to select a tone reservation pattern corresponding to each bandwidth part, and establish the mapping relationship between a tone reservation pattern and an index of a bandwidth part. In other words, the first communication device and the second communication device perform data transmission by using a tone reservation pattern corresponding to the first bandwidth part, so that the PARA of the signal can be effectively suppressed.

For example, in Table 2, an example in which a bandwidth part 1 is a 200 M bandwidth (where a carrier spacing is 120 kHz), an FFT length or an IFFT length is 2048, and the tone reservation pattern is distributed in the bandwidth part is used. A tone reservation pattern that can better suppress the PAPR of the signal is designed to establish a mapping relationship between the tone reservation pattern and the bandwidth part 1.

For another example, an example in which a bandwidth part 3 is a 30 M bandwidth (where a carrier spacing is 120 kHz), an FFT length or an IFFT length is 1024, and the tone reservation pattern is distributed in the bandwidth part is used. A tone reservation pattern that can better suppress the PAPR of signal is designed to establish a mapping relationship between the tone reservation pattern and the bandwidth part 3.

In another possible implementation, the first mapping relationship is a mapping relationship between a tone reservation pattern and configuration information of a bandwidth part. The first communication device determines, from the plurality of tone reservation patterns based on the first mapping relationship, a first tone reservation pattern corresponding to configuration information of the first bandwidth part. Optionally, the configuration information of the bandwidth part includes a bandwidth and a carrier spacing of the bandwidth part.

For example, the following indicates, by using Table 3, the mapping relationship between a tone reservation pattern and configuration information of a bandwidth part. The configuration information of the bandwidth part is described by using the bandwidth and the carrier spacing of the bandwidth part as an example.

TABLE 3

| Configuration | |
|---|---|
| information of a | |
| bandwidth part BWP | Tone reservation pattern (TR pattern) |
| 200M bandwidth and | 2 3 13 19 20 29 39 40 44 45 49 69 79 89 94 105 136 141 157 213 |
| 120 kHz subcarrier | 220 246 293 912 919 961 1003 1073 1085 1129 1138 1145 1146 |
| spacing | 1181 1236 1264 1269 1302 1308 1321 1396 1402 1449 1452 1506 |
| | 1507 1516 1521 1532 1533 1537 1549 1550 1557 1564 1575 1583 |
| 30M bandwidth and | 2 7 8 9 11 15 16 17 18 20 21 22 23 26 28 31 33 36 144 154 156 165 |
| 120 kHz carrier | 186 189 190 206 209 210 223 227 229 230 231 234 238 240 |
| spacing | |

For example, if the configuration information of the first bandwidth part includes the 30 M bandwidth and the 120 kHz carrier spacing, the first communication device may determine, by using Table 3, that the first tone reservation pattern corresponding to the configuration information of the first bandwidth part is {2 7 8 9 11 15 16 17 18 20 21 22 23 26 28 31 33 36 144 154 156 165 186 189 190 206 209 210 223 227 229 230 231 234 238 240}.

An establishment process of Table 3 is similar to an establishment process of Table 2. For details, refer to the foregoing related descriptions. Details are not described herein again.

For a manner in which the second communication device indicates the first mapping relationship to the first communication device, optionally, the embodiment shown in FIG. 5 further includes step 501a. Step 501a may be performed before step 501.
501a: The second communication device sends second configuration information to the first communication device. Correspondingly, the first communication device receives the second configuration information from the second communication device.

First configuration information indicates the first mapping relationship. In a possible implementation, the first configuration information includes the first mapping relationship.

Optionally, the first configuration information further includes at least one of the following configuration parameters: the plurality of tone reservation patterns, indexes of the plurality of tone reservation patterns, the mapping relationship between a tone reservation pattern and an index, a second mapping relationship, a third mapping relationship, and a fourth mapping relationship.

The second mapping relationship is a mapping relationship between a tone reservation pattern and a beam. The third mapping relationship is a mapping relationship between a tone reservation pattern and a plurality of bandwidth parts corresponding to each of a plurality of beams. The fourth mapping relationship is a mapping relationship that is between a tone reservation pattern and a reference signal pattern and that is used when the first communication device and the second communication device use each of the plurality of bandwidth parts. For related descriptions of the second mapping relationship, the third mapping relationship, and the fourth mapping relationship, refer to the following related descriptions. Details are not described herein.

In some implementation manners, each configuration parameter included in the second configuration information may be carried in any one of the following signaling: a SIB 1, a MIB, RRC signaling, DCI, group DCI, a MAC CE, or a TAC.

For example, the first communication device is a terminal device, and the terminal device performs the embodiment shown in FIG. 2 in an initial access process. The first mapping relationship may be carried in the SIB 1, the MIB, or the RRC signaling.

Implementation 4

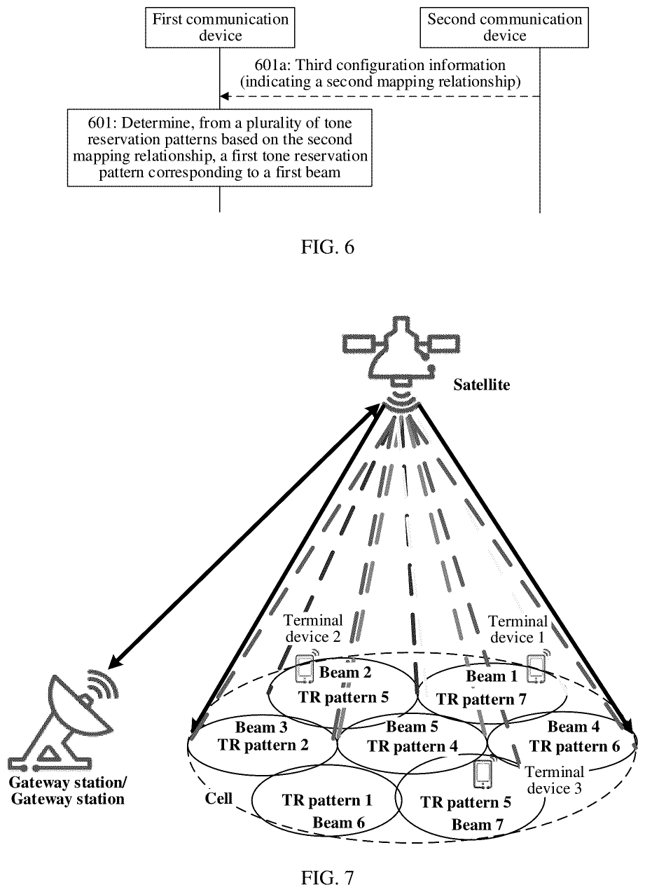

The following describes Implementation 4 with reference to an embodiment shown in FIG. 6.
601: A first communication device determines, from a plurality of tone reservation patterns based on a second mapping relationship, a first tone reservation pattern corresponding to a first beam.

The second mapping relationship is a mapping relationship between a tone reservation pattern and a beam.

Optionally, the second mapping relationship may be preconfigured, indicated by a second communication device to the first communication device, or specified in a communication protocol. This is not specifically limited in this application.

The first communication device stores the plurality of tone reservation patterns. The plurality of tone reservation patterns may be preconfigured, sent by the second communication device to the first communication device, or specified in a communication protocol. This is not specifically limited in this application.

For example, the following indicates, by using Table 4, the mapping relationship between a tone reservation pattern and a beam.

TABLE 4

| Beam | |
|---|---|
| number | Tone reservation pattern (TR pattern) |
| 0 | 2 7 8 9 11 15 16 17 18 20 21 22 23 26 28 31 33 36 144 154 156 165 186 189 190 |
| | 206 209 210 223 227 229 230 231 234 238 240 |
| 1 | 2 4 10 12 14 16 18 20 22 24 26 28 34 36 38 126 146 150 152 154 176 182 184 |
| | 186 188 200 204 210 212 214 216 220 226 228 230 232 234 236 238 240 |
| 2 | 2 4 6 7 8 10 11 14 16 18 20 28 30 31 32 35 38 40 138 139 154 156 160 174 175 |
| | 195 196 200 211 212 214 216 220 222 223 228 230 232 236 239 |
| 3 | 1 4 5 7 8 9 11 13 16 17 20 28 29 31 32 35 37 40 137 139 153 156 160 173 175 |
| | 195 196 200 211 212 213 216 220 221 223 228 229 232 236 239 |
| . . . | . . . |

For example, if the beam number of the first beam is 0, the first communication device may determine, by using Table 4, that the first tone reservation pattern is {2 7 8 9 11 15 16 17 18 21 22 23 26 28 31 33 36 144 154 156 165 186 189 190 206 209 210 223 227 229 230 231 234 238 240}. The first communication device receives a kernel signal from the second communication device on a reserved carrier included in the first tone reservation pattern, and receives a data signal from a transmitting device on a carrier other than the reserved carrier in a bandwidth part based on resource scheduling on a network side. After converting the received signal to frequency domain, the first communication device skips the reserved carrier indicated by the first tone reservation pattern when selecting data on a corresponding carrier. In other words, the first communication device does not perform decoding processing on data on the reserved carrier included in the first tone reservation pattern.

Optionally, for establishment of the mapping relationship between a tone reservation pattern and a beam, at least one of the following factors may be considered: a bandwidth used for communication between the first communication device and the second communication device in the beam, an FFT length or an IFFT length, and distribution of a reserved carrier included in the tone reservation pattern. For distribution of the reserved carrier included in the tone reservation pattern, refer to the foregoing related descriptions.

For example, the second communication device uses, as considered factors, the bandwidth used for communication between the first communication device and the second communication device in the beam, the FFT length or the IFFT length, and distribution of the reserved carrier included in the tone reservation pattern, and traverses all tone reservation patterns to optimize a suppression effect of PARA, to select a tone reservation pattern corresponding to each beam, and establish the mapping relationship between a tone reservation pattern and a beam. In other words, the first communication device and the second communication device perform data transmission by using the tone reservation pattern corresponding to the first beam, so that the PARA of the signal can be effectively suppressed.

For example, in Table 4, an example in which communication between the first communication device and the second communication device is performed on a beam 0 by using a 30 M bandwidth (where a carrier spacing is 120 kHz), an FFT length or an IFFT length is 1024, and the tone reservation pattern is distributed in a bandwidth part is used. Atone reservation pattern that can better suppress a PAPR of the signal is designed to establish a mapping relationship between the tone reservation pattern and the beam 0.

For example, in a satellite communication system shown in FIG. 7, the first communication device is a terminal device 1, and the terminal device 1 accesses a beam 1. Therefore, the terminal device 1 may determine that the beam 1 corresponds to a tone reservation pattern 7.

For a manner in which the second communication device indicates a first mapping relationship to the first communication device, optionally, the embodiment shown in FIG. 6 further includes step 601a. Step 601a may be performed before step 601.
601a: The second communication device sends third configuration information to the first communication device. Correspondingly, the first communication device receives the third configuration information from the second communication device. The third configuration information indicates the second mapping relationship.

In a possible implementation, the third configuration information includes the second mapping relationship.

In some implementation manners, the third configuration information further includes at least one of the following configuration parameters: the plurality of tone reservation patterns, indexes of the plurality of tone reservation patterns, a mapping relationship between a tone reservation pattern and an index, the first mapping relationship, a third mapping relationship, and a fourth mapping relationship. For the first mapping relationship, refer to the related descriptions in FIG. 4. Details are not described herein again. For related descriptions of the third mapping relationship and the fourth mapping relationship, refer to the following related descriptions. Details are not described herein.

A manner of carrying each configuration parameter in the third configuration information is similar to a manner of carrying each configuration parameter in the second configuration information in step 501a. For details, refer to the related descriptions in step 501a. Details are not described herein again.

Optionally, two different beams may correspond to a same tone reservation pattern. A distance between signal coverage areas of the two beams is large, and the two beams correspond to a same bandwidth part. For example, as shown in FIG. 7, a distance between a signal coverage area of a beam 2 and a signal coverage area of a beam 7 is large. Therefore, both the beam 2 and the beam 7 may correspond to a tone reservation pattern 5. A terminal device 2 accesses the beam 2, and performs data transmission by using the tone reservation pattern 7. A terminal device 3 accesses the beam 7, and performs data transmission by using the tone reservation pattern 5. No interference is generated between the terminal device 2 and the terminal device 3, or interference is small (where the interference can be ignored).

Implementation 5

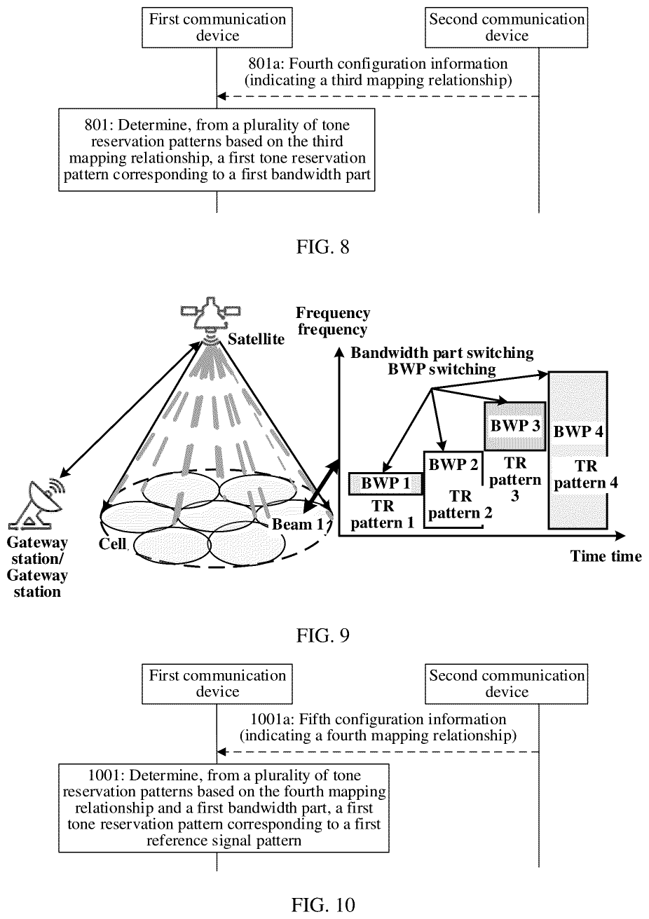

The following describes Implementation 5 with reference to an embodiment shown in FIG. 8.
801: A first communication device determines, from a plurality of tone reservation patterns based on a third mapping relationship, a first tone reservation pattern corresponding to a first bandwidth part.

The third mapping relationship is a mapping relationship between a tone reservation pattern and a plurality of bandwidth parts corresponding to each of a plurality of beams. The plurality of beams include a first beam.

Optionally, the third mapping relationship may be preconfigured, indicated by a second communication device to the first communication device, or specified in a communication protocol. This is not specifically limited in this application. The first communication device stores the plurality of tone reservation patterns. The plurality of tone reservation patterns may be preconfigured, sent by the second communication device to the first communication device, or specified in a communication protocol. This is not specifically limited in this application.

In a possible implementation, the third mapping relationship is a mapping relationship between a tone reservation pattern and indexes of the plurality of bandwidth parts corresponding to each of the plurality of beams; or the third mapping relationship is a mapping relationship between a tone reservation pattern and configuration information of the plurality of bandwidth parts corresponding to each of the plurality of beams. Optionally, configuration information of a bandwidth part includes a bandwidth and a carrier spacing of the bandwidth part. The following uses an example in which the third mapping relationship is the mapping relationship between a tone reservation pattern and indexes of the plurality of bandwidth parts corresponding to each of the plurality of beams for description.

For example, the following indicates, by using Table 5, the mapping relationship between a tone reservation pattern and indexes of the plurality of bandwidth parts corresponding to each beam.

TABLE 5

| | Index of a | |
|---|---|---|
| Beam | bandwidth | |
| number | part | Tone reservation pattern (TR pattern) |
| 0 | 0 | 2 7 8 9 11 15 16 17 18 20 21 22 23 26 28 31 33 36 144 154 156 |
| | | 165 186 189 190 206 209 210 223 227 229 230 231 234 238 240 |
| | 1 | 5 6 7 11 29 31 71 79 83 85 99 111 138 161 166 181 183 194 210 |
| | | 240 263 272 301 305 800 959 985 988 1001 1160 1203 1225 1244 |
| | | 1265 1298 1334 1343 1372 1377 1385 1390 1401 1405 1439 1448 |
| | | 1455 1472 1481 1482 1514 1527 1544 1555 1562 1563 1564 1571 |
| 1 | 0 | 2 4 6 7 8 10 11 14 16 18 20 28 30 31 32 35 38 40 138 139 154 156 |
| | | 160 174 175 195 196 200 211 212 214 216 220 222 223 228 230 |
| | | 232 236 239 |
| | 1 | 2 3 13 19 20 29 39 40 44 45 69 79 89 94 105 136 141 157 213 220 |
| | | 246 293 912 919 1003 1073 1085 1138 1145 1146 1181 1236 1264 |
| | | 1269 1302 1308 1396 1402 1449 1452 1506 1507 1516 1521 1532 |
| | | 1533 1549 1550 1557 1564 1575 1583 |
| | . . . | . . . |

In Table 5, configuration information of the bandwidth part corresponding to the index 0 may include any one of the following:
a 30 M bandwidth, a 120 kHz (kilohertz) carrier spacing, and an FFT length or an IFFT length of 1024,
a 15 M bandwidth, a 60 kHz one spacing, and an FFT length or an IFFT length of 1024,
a 7.5 M bandwidth, a 30 kHz carrier spacing, and an FFT length or an IFFT length of 1024, or
a 3.75 M bandwidth, a 15 kHz carrier spacing, and an FFT length or an IFFT length of 1024.

In Table 5, configuration information of the bandwidth part corresponding to the index 1 may include any one of the following:
a 200 M bandwidth, a 120 kHz carrier spacing, and an FFT length or an IFFT length of 2048,
a 100 M bandwidth, a 60 kHz carrier spacing, and an FFT length or an IFFT length of 2048,
a 50 M bandwidth, a 30 kHz carrier spacing, and an FFT length or an IFFT length of 2048, or
a 25 M bandwidth a 15 kHz carrier spacing, and an FFT length or an IFFT length of 2048.

For example, if a beam number of the first beam is 0, and the first bandwidth part is the bandwidth part corresponding to the index 0, it can be learned from Table 5 that the first tone reservation pattern is {2 7 8 9 11 15 16 17 18 20 21 22 23 26 28 31 33 36 144 154 156 165 186 189 190 206 209 210 223 227 229 230 231 234 238 240}. The first communication device receives, on a beam 0 by using the tone reservation pattern corresponding to the index 0, a signal sent by the second communication device. After converting the received signal to frequency domain, the first communication device skips a reserved carrier indicated by the tone reservation pattern corresponding to the index 0 when selecting data on a corresponding carrier. In other words, the first communication device does not perform decoding processing on data on the reserved carrier included in the tone reservation pattern corresponding to the index 0.

For example, as shown in FIG. 9, a beam 1 corresponds to a bandwidth part 1, a bandwidth part 2, a bandwidth part 3, and a bandwidth part 4. An index of the bandwidth part 1 is 1, an index of the bandwidth part 2 is 2, an index of the bandwidth part 3 is 3, and an index of the bandwidth part 4 is 4. The index 1 corresponds to a tone reservation pattern 1, the index 2 corresponds to a tone reservation pattern 2, the index 3 corresponds to a tone reservation pattern 3, and the index 4 corresponds to a tone reservation pattern 4. The first communication device uses the bandwidth part 1 corresponding to the beam 1. Therefore, the first communication device may determine the tone reservation pattern 1 corresponding to the index 1 of the bandwidth part 1, and communicate a data signal by using the tone reservation pattern 1.

Optionally, for establishment of the third mapping relationship, at least one of the following factors may be considered: bandwidth parts corresponding to each beam, bandwidths, carrier spacings, and FFT lengths or IFFT lengths of the bandwidth parts corresponding to each beam, and distribution of a reserved carrier included in the tone reservation pattern. For distribution of the reserved carrier included in the tone reservation pattern, refer to the foregoing related descriptions.

For example, the second communication device uses, as considered factors, the bandwidth parts corresponding to each beam, the bandwidths, the carrier spacings, and the FFT lengths or the IFFT lengths of the bandwidth parts corresponding to each beam, and distribution of the reserved carrier included in the tone reservation pattern, and traverses all tone reservation patterns to optimize a suppression effect of PARA, to select a tone reservation pattern corresponding to each of the plurality of bandwidth parts corresponding to each beam.

For example, in Table 5, the beam 0 corresponds to a bandwidth part 0 and a bandwidth part 1. The bandwidth part 0 is a 30 M bandwidth (where a carrier spacing is 120 kHz), an FFT length or an IFFT length is 1024, and the tone reservation pattern is distributed in the bandwidth part. A tone reservation pattern that can better suppress the PAPR of the signal is designed to establish a mapping relationship between the tone reservation pattern and the bandwidth part 0 corresponding to the beam 0.

For a manner in which the second communication device indicates the third mapping relationship to the first communication device, optionally, the embodiment shown in FIG. 8 further includes step 801a. Step 801a may be performed before step 801.
801a: The second communication device sends fourth configuration information to the first communication device. Correspondingly, the first communication device receives the fourth configuration information from the second communication device. The fourth configuration information indicates the third mapping relationship.

In a possible implementation, the fourth configuration information includes the third mapping relationship.

In some implementation manners, the fourth configuration information further includes at least one of the following configuration parameters: the plurality of tone reservation patterns, indexes of the plurality of tone reservation patterns, a mapping relationship between a tone reservation pattern and an index, a first mapping relationship, a second mapping relationship, and a fourth mapping relationship. For the first mapping relationship and the second mapping relationship, respectively refer to the related descriptions in FIG. 5 and FIG. 6. Details are not described herein again. For related descriptions of the fourth mapping relationship, refer to the following related descriptions. Details are not described herein. A manner of carrying each configuration parameter in the fourth configuration information is similar to a manner of carrying each configuration parameter in the first configuration information in step 501a. For details, refer to the related descriptions in step 501a. Details are not described herein again.

Implementation 6

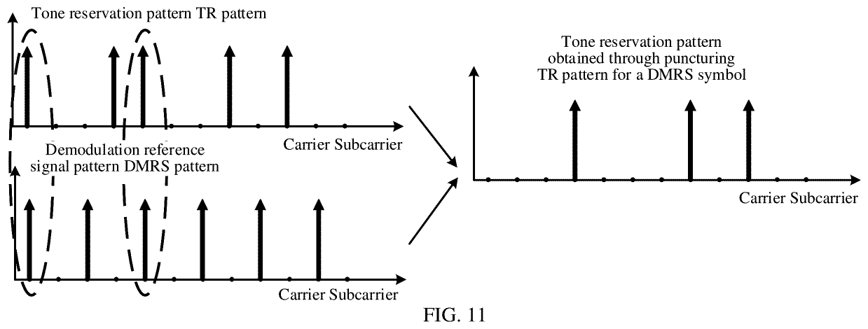

The following describes Implementation 6 with reference to an embodiment shown in FIG. 10.

FIG. 10 is a schematic diagram of another embodiment of a communication processing method according to an embodiment of this application. Refer to FIG. 10. The communication processing method includes the following steps.
1001: A first communication device determines, from a plurality of tone reservation patterns based on a fourth mapping relationship and a first bandwidth part, a tone reservation pattern corresponding to a first reference signal pattern.

The fourth mapping relationship is a mapping relationship that is between a tone reservation pattern and a reference signal pattern and that is used when the first communication device and a second communication device use each of a plurality of bandwidth parts. The first reference signal pattern is a pattern that is sampled when the first communication device communicates a reference signal.

Optionally, the reference signal includes any one of the following: a PTRS, a channel-state information reference signal (channel-state information reference signal, CSI-RS), a DMRS, or a tracking reference signal (tracking reference signal, TRS).

Optionally, a reference signal pattern may be represented by using a configuration parameter of the reference signal, for example, a frequency-domain density of the reference signal. For example, the frequency-domain density of the reference signal may be indicated by every specific quantity of resource blocks (resource blocks, RBs) being mapped to one reference signal or by every specific quantity of carriers being mapped to one reference signal. Optionally, the fourth mapping relationship includes a mapping relationship that is between a tone reservation pattern and the frequency-domain density of the reference signal and that is used when the first communication device and the second communication device use each of the plurality of bandwidth parts.

For example, the following indicates, by using Table 6, the mapping relationship that is between the tone reservation pattern and the frequency-domain density of the reference signal and that is used when the first communication device and the second communication device use the first bandwidth part. Table 6 uses the PTRS as an example. The frequency-domain density of the reference signal in Table 6 indicates that every K_{PT-RS} RBs are mapped to one PTRS.

TABLE 6

| Frequency-domain | |
|---|---|
| density K_{PT-RS} of a | |
| reference signal | Tone reservation pattern |
| 2 | 2 3 13 19 20 29 39 40 44 45 69 79 89 94 105 136 141 157 213 220 |
| | 246 293 912 919 1003 1073 1085 1138 1145 1146 1181 1236 1264 |
| | 1269 1302 1308 1396 1402 1449 1452 1506 1507 1516 1521 1532 |
| | 1533 1549 1550 1557 1564 1575 1583 |
| 4 | 4 10 13 22 28 37 39 58 89 109 123 140 154 161 166 189 190 207 214 |
| | 229 290 323 325 327 335 911 965 1035 1065 1170 1181 1282 1288 |
| | 1317 1348 1386 1397 1412 1414 1419 1440 1461 1464 1466 1467 |
| | 1469 1512 1534 1541 1543 1544 1550 1551 1553 1568 |
| . . . | . . . |

For example, if the reference signal is the PTRS, and a frequency-domain density of the PTRS is 2, the first communication device may determine, by using Table 6, that a first tone reservation pattern is {2 3 13 19 20 29 39 40 44 45 69 79 89 94 105 136 141 157 213 220 246 293 912 919 1003 1073 1085 1138 1145 1146 1181 1236 1264 1269 1302 1308 1396 1402 1449 1452 1506 1507 1516 1521 1532 1533 1549 1550 1557 1564 1575 1583}.

When establishing the mapping relationship between the frequency-domain density of the reference signal and the tone reservation pattern, it may be considered that a location of a reserved carrier included in the tone reservation pattern is avoided from a carrier location occupied by the reference signal, to avoid carrier overlapping. If the first communication device and the second communication device use the tone reservation pattern, a secondary peak value of an obtained time domain kernel signal may be small or a ratio of a primary peak to a secondary peak may be large. In this way, it can be ensured that complete transmission of the reference signal (to ensure decoding performance), and a good signal suppression effect of PAPR of a signal. The mapping relationship between the tone reservation pattern and the frequency-domain density of the reference signal shown in Table 6 is designed and obtained according to the foregoing shown design principle.

It should be noted that in Table 6, an example in which every specific quantity of RBs are mapped to one PTRS is used for describing the frequency-domain density of the reference signal. In actual application, the frequency-domain density of the reference signal may alternatively be indicated in another manner. For example, the frequency-domain density of the reference signal is every specific quantity of carriers being mapped to one PTRS. This is not specifically limited in this application.

For example, the following indicates, by using Table 7, the mapping relationship that is between the tone reservation pattern and the frequency-domain density of the reference signal and that is used when the first communication device and the second communication device use the first bandwidth part, and the mapping relationship between the frequency-domain density of the reference signal and the tone reservation pattern that is sampled by the first communication device and the second communication device when a second bandwidth part is used. The frequency-domain density of the reference signal in Table 7 indicates that every specific quantity of carriers are mapped to one reference signal.

TABLE 7

| Index of a | Frequency- | |
|---|---|---|
| bandwidth | domain density of | |
| part | a reference signal | Tone reservation pattern |
| 0 | 2 | 2 28 40 42 68 72 82 84 122 140 160 184 212 890 930 988 |
| | | 1032 1086 1104 1162 1168 1270 1284 1328 1352 1388 |
| | | 1390 1394 1396 1442 1454 1504 1522 1524 1554 1582 |
| | 24 | 2 3 13 19 20 29 39 40 44 45 69 79 89 94 105 136 141 157 |
| | | 213 220 246 293 912 919 1003 1073 1085 1138 1145 |
| | | 1146 1181 1236 1264 1269 1302 1308 1396 1402 1449 |
| | | 1452 1506 1507 1516 1521 1532 1533 1549 1550 1557 |
| | | 1564 1575 1583 |
| 1 | 2 | 2 4 10 12 14 16 18 20 22 24 26 28 34 36 38 126 146 150 |
| | | 152 154 176 182 184 186 188 200 204 210 212 214 216 |
| | | 220 226 228 230 232 234 236 238 240 |
| | 4 | 2 4 6 7 8 10 11 14 16 18 20 28 30 31 32 35 38 40 138 139 |
| | | 154 156 160 174 175 195 196 200 211 212 214 216 220 |
| | | 222 223 228 230 232 236 239 |
| | 24 | 2 7 8 9 11 15 16 17 18 20 21 22 23 26 28 31 33 36 144 |
| | | 154 156 165 186 189 190 206 209 210 223 227 229 230 |
| | | 231 234 238 240 |

In Table 7, configuration information of the bandwidth part corresponding to the index 0 may include any one of the following: a 200 M bandwidth, a 120 kHz carrier spacing, and an FFT length or an IFFT length of 2048, a 100 M bandwidth, a 60 kHz carrier spacing, and an FFT length or an IFFT length of 2048, a 50 M bandwidth, a 30 kHz carrier spacing, and an FFT length or an IFFT length of 2048, or a 25 M bandwidth, a 15 kHz carrier spacing, and an FFT length or an IFFT length of 2048.

Configuration information of the bandwidth part corresponding to the index 1 may include any one of the following: a 30 M bandwidth, a 120 kHz carrier spacing, and an FFT length or an IFFT length of 1024, a 15 M bandwidth, a 60 kHz carrier spacing, and an FFT length or an IFFT length of 1024, a 7.5 M bandwidth, a 30 kHz carrier spacing, and an FFT length or an IFFT length of 1024, or a 3.75 M bandwidth, a 15 kHz carrier spacing, and an FFT length or an IFFT length of 1024.

For example, if the first bandwidth part is the bandwidth part corresponding to the index 0, and the frequency-domain density of the reference signal is 2, the first communication device may determine, by using Table 7, that a first tone reservation pattern is {2 28 40 42 68 72 82 84 122 140 160 184 212 890 930 988 1032 1086 1104 1162 1168 1270 1284 1328 1352 1388 1390 1394 1396 1442 1454 1504 1522 1524 1554 1582}.

Optionally, for establishment of the fourth mapping relationship, at least one of the following factors may be considered: a frequency-domain density of a to-be-used reference signal that exists in each bandwidth part, a bandwidth part, a carrier spacing, an FFT length or an IFFT length, and distribution of a tone reservation pattern. For distribution of the tone reservation pattern, refer to the foregoing related descriptions. Details are not described herein again.

For example, in Table 7, in the bandwidth part corresponding to the index 0, frequency-domain densities of the reference signal are 2 and 24. The bandwidth part corresponding to the index 0 is the 200 M bandwidth (where the carrier spacing is 120 kHz), and an FFT length or an IFFT length is 2048. Reserved carriers included in the tone reservation pattern are distributed in the bandwidth part. A tone reservation pattern that can better suppress the PAPR of the signal is designed to establish the mapping relationship between the tone reservation pattern and the frequency-domain density of the reference signal.

For example, in Table 7, in the bandwidth part corresponding to the index 1, the frequency-domain density of the reference signal is 2, 4 or 24. The bandwidth part corresponding to the index 1 is the 30 M bandwidth (where the carrier spacing is 120 kHz), and an FFT length or an IFFT length is 1024. Reserved carriers included in the tone reservation pattern are distributed in the bandwidth part. A tone reservation pattern that can better suppress the PAPR of the signal is designed to establish the mapping relationship between the tone reservation pattern and the frequency-domain density of the reference signal.

In Table 7, the frequency-domain density of the reference signal is 2, indicating that every two carriers are mapped to one reference signal. The frequency-domain density of the reference signal is 4, indicating that every four carriers are mapped to one reference signal. The frequency-domain density of the reference signal is 24, indicating that every 24 carriers are mapped to one reference signal. For example, the frequency-domain density of the reference signal is 2, indicating that the reference signal is communicated on the 1^{st} carrier, the 3^{rd} carrier, the 5^{th} carrier, the 7^{th} carrier, . . . , and the like.

It should be noted that in Table 7, an example in which every specific quantity of carriers are mapped to one reference signal is used for describing the frequency-domain density of the reference signal. In actual application, the frequency-domain density of the reference signal is indicated in another manner. For example, the frequency-domain density of the reference signal is every specific quantity of RBs being mapped to one reference signal. In this case, in Table 6, frequency-domain densities of the reference signal are 2, 4, and 24 respectively may be replaced with frequency-domain densities of the reference signal being ½, ¼, and 1/24.

Optionally, the fourth mapping relationship may be preconfigured, indicated by the second communication device to the first communication device, or specified in a communication protocol. This is not specifically limited in this application. The first communication device stores the plurality of tone reservation patterns. For example, the plurality of tone reservation patterns include tone reservation patterns shown in Table 7. The plurality of tone reservation patterns may be preconfigured, sent by the second communication device to the first communication device, or specified in the communication protocol. This is not specifically limited in this application.

For a manner in which the second communication device indicates the fourth mapping relationship to the first communication device, optionally, the embodiment shown in FIG. 10 further includes step 1001a. Step 1001a may be performed before step 1001.
1001a: The second communication device sends fifth configuration information to the first communication device. Correspondingly, the first communication device receives the fifth configuration information from the second communication device. The fifth configuration information indicates the fourth mapping relationship.

In some implementation manners, the fifth configuration information further includes at least one of the following configuration parameters: the plurality of tone reservation patterns, indexes of the plurality of tone reservation patterns, a mapping relationship between the tone reservation pattern and an index, a first mapping relationship, a second mapping relationship, and a third mapping relationship. For related descriptions of the first mapping relationship, the second mapping relationship, and the third mapping relationship, refer to the foregoing related descriptions. Details are not described herein again. A manner of carrying each configuration parameter in the fifth configuration information is similar to a manner of carrying each configuration parameter in the first configuration information in step 501a. For details, refer to the related descriptions in step 501a. Details are not described herein again.

In step 201a of the embodiment shown in FIG. 2, the first communication device determines whether to communicate the data signal by using the tone reservation pattern. The following describes a specific determining process of the first communication device in step 201a with reference to step 1 and step 2.
Step 1: A first communication device obtains first indication information. The first indication information indicates to the first communication device whether to communicate a data signal by using a tone reservation pattern.

The following describes several possible indication manners of the first indication information. This application is still applicable to another indication manner. This is not specifically limited in this application.
Indication manner 1: First indication information indicates location information of a third communication device.

The third communication device is configured to communicate between a first communication device and a second communication device. The third communication device and the first communication device are two different communication devices. The first indication information is from the second communication device or from an intermediate node device, for example, the third communication device.

For example, as shown in FIG. 1B, the third communication device is the satellite. The first communication device and the second communication device perform communication transmission through the satellite. Location information of the satellite is included in ephemeris information of the satellite, for example, an orbital height of the satellite, a moving speed of the satellite, and a tilt angle of a satellite orbit.

For an implementation in which the first indication information is from the second communication device, step 1 specifically includes: The second communication device sends the first indication information to the first communication device. Correspondingly, the first communication device receives the first indication information from the second communication device.
Indication manner 2: First indication information indicates to a first communication device whether to communicate, by using a tone reservation pattern, a data signal carried in each of a plurality of beams.

For example, as shown in FIG. 1B, a signal coverage area of the satellite includes a beam 1 to a beam 5. The first indication information indicates to the first communication device whether to communicate, by using the tone reservation pattern, the data signal carried in each of the beam 1 to a beam 3, and indicates the first communication device to communicate, by using no tone reservation pattern, the data signal carried in each of a beam 4 and the 5.

Optionally, the first indication information is carried in a broadcast message. For example, the broadcast message is a SIB 1 or a MIB sent by a second communication device to the first communication device.
Step 2: The first communication device determines, based on the first indication information, whether to communicate the data signal by using the tone reservation pattern, and if the first communication device determines, based on the first indication information, to communicate the data signal by using the tone reservation pattern, step 201 in the embodiment shown in FIG. 2 is performed, or if the first communication device determines, based on the first indication information, to communicate the data signal by using no tone reservation pattern, step 204 in the embodiment shown in FIG. 2 is performed.

Based on the indication manner 1 in step 1, the first communication device determines, based on the location information of the third communication device, whether to communicate the data signal by using the tone reservation pattern. If the first communication device determines, based on the location information of the third communication device, to communicate the data signal by using the tone reservation pattern, step 201 in the embodiment shown in FIG. 2 is performed. If the first communication device determines, based on the location information of the third communication device, to communicate the data signal by using no tone reservation pattern, step 204 in the embodiment shown in FIG. 2 is performed.

In a possible implementation, the third communication device is the satellite. The location information of the satellite includes the ephemeris information of the satellite. The first communication device determines, based on the ephemeris information of the satellite, whether to communicate the data signal by using the tone reservation pattern.

For example, the ephemeris information of the satellite includes the orbit height of the satellite. If the orbit height of the satellite is greater than a first threshold, the first communication device communicates the data signal by using the tone reservation pattern. If the orbit height of the satellite is less than or equal to the first threshold, the first communication device communicates the data signal by using the tone reservation pattern. For example, the first threshold is 200 km (kilometer).

Optionally, a value of the first threshold may be set with reference to a signal-to-noise ratio requirement of a receiving end. For example, when an orbit height between the first communication device and the satellite exceeds 200 km (kilometer), the first communication device communicates with the satellite. The first communication device sends a signal to the satellite, and a signal-to-noise ratio of the signal received by the satellite is low. The first communication device needs to increase transmit power to increase the signal-to-noise ratio of the satellite. Therefore, the first communication device needs to use the tone reservation pattern for suppressing PAPR of the signal to increase the transmit power. In other words, the first threshold may be set to 200 km.

Based on the indication manner 2 in step 2, the first communication device determines, based on the first indication information, whether the data signal is carried on a first beam. If the first communication device determines, based on the first indication information, that the data signal is carried on the first beam, step 201 in the embodiment shown in FIG. 2 is performed. If the first communication device determines, based on the first indication information, that the data signal is not carried on the first beam, step 204 in the embodiment shown in FIG. 2 is performed.

For example, the first communication device performs data transmission through the beam 1. The first indication information indicates the first communication device to communicate, by using the tone reservation pattern, the data signal carried on the beam 1. Therefore, the first communication device may determine to communicate, by using the tone reservation pattern, the data signal carried on the beam 1.

It should be noted that the indication manner 1 in step 1 shows that the third communication device and the first communication device are two different communication devices. Actually, the third communication device and the first communication device may alternatively be a same communication device. The first communication device obtains location information of the first communication device. Then, the first communication device determines, based on the location information of the first communication device, whether to communicate the data signal by using the tone reservation pattern.

For example, the first communication device is a high-altitude terminal device. Location information of the high-altitude terminal device includes height information of the high-altitude terminal device. Then, the high-altitude terminal device determines, based on the height information of the high-altitude terminal device, whether to communicate the data signal by using the tone reservation pattern.

For example, as shown in FIG. 1C, the first communication device is the airplane shown in FIG. 1C. Location information of the airplane includes a flight altitude of the airplane, a relative altitude difference between the airplane and a sea horizon, and the like. If the relative height difference between the high-altitude terminal device and the sea horizon is greater than a second threshold, the high-altitude terminal device communicates the data signal by using the tone reservation pattern. If the relative height difference between the high-altitude terminal device and the sea horizon is less than or equal to the second threshold, the high-altitude terminal device communicates the data signal by using the tone reservation pattern.

Optionally, a value of the second threshold may be set with reference to a signal-to-noise ratio requirement of a receiving end.

For example, the high-altitude terminal device sends the data signal to the second communication device. If the signal-to-noise ratio of the signal received by the second communication device is low, the high-altitude terminal device needs to increase the transmit power to increase the signal-to-noise ratio of the receiving end. Therefore, the high-altitude terminal device may send the data signal by using the tone reservation pattern to suppress the PAPR of the signal, to increase the transmit power. The second threshold may be a relative height between the high-altitude terminal device and the sea horizon when the signal-to-noise ratio of the signal received by the receiving end is less than a specific value.

For example, the first communication device is the satellite. The location information of the satellite may be included in the ephemeris information of the satellite. The satellite determines, based on the ephemeris information of the satellite, whether to communicate the data signal by using the tone reservation pattern.

For example, as shown in FIG. 1D, the first communication device is the satellite shown in FIG. 1D. The satellite also has a function of a network device. The location information of the satellite is included in the ephemeris information of the satellite. For the ephemeris information and a process in which the satellite determines whether to communicate the data signal by using the tone reservation pattern, refer to the foregoing related descriptions. Details are not described herein again.

In step 201 of the embodiment shown in FIG. 2, optionally, if on a same frequency domain resource, a reserved carrier in the first tone reservation pattern overlaps a carrier that is on the first communication device and that is used for communicating a reference signal, step 202 specifically includes step 202a and step 202b.
Step 202a: The first communication device punctures an overlapping reserved carrier in the first tone reservation pattern to obtain a fifth tone reservation pattern.

The overlapping tone reservation pattern is a reserved carrier that is in the first tone reservation pattern and that overlaps the carrier used for communicating the reference signal. The overlapping tone reservation pattern means that the carrier both serves as a reserved carrier and serves as a carrier used for communicating the reference signal. For example, the first communication device is a terminal device, and the terminal device receives, on the reserved carrier, a kernel signal from a network device. The network device configures the terminal device to receive the reference signal on the reserved carrier. Because the terminal device does not perform decoding processing on a signal received on the reserved carrier, the first communication device cannot decode the reference signal. Therefore, the first communication device may puncture the overlapping tone reservation pattern in the first tone reservation pattern, so that the first communication device communicates the reference signal.

For example, one bandwidth part includes 2048 carriers. On one symbol, the first tone reservation pattern is {2 28 39 40 42 65 68 72 82 83 84 85 91 115 117 122 140 159 160 184 212 223 817 890 930 949 988 1032 1086 1104 1162 1168 1223 1267 1270 1277 1284 1328 1345 1352 1388 1389 1390 1394 1396 1405 1442 1454 1471 1504 1522 1524 1553 1554 1563 1582 1583}.

If a frequency-domain density of a PTRS is 2, in other words, every two RBs are mapped to one PTRS on one symbol, to be specific, a reference signal of the PTRS is communicated on the first one, the 25^{th} carrier, the 49^{th} carrier, the 73^{rd} carrier, the 97^{th} carrier, . . . , and the like, the first communication device punctures the first tone reservation pattern to obtain a punctured fifth tone reservation pattern: {2 28 39 40 42 65 68 72 82 83 84 85 91 115 117 122 140 159 160 184 212 223 890 930 949 988 1032 1086 1104 1162 1168 1223 1267 1270 1277 1284 1328 1352 1388 1389 1390 1394 1396 1405 1442 1454 1471 1504 1522 1524 1553 1554 1563 1582 1583}.

For example, if one bandwidth part includes 2048 carriers, on one symbol, the first tone reservation pattern is {2 28 39 40 42 65 68 72 82 83 84 85 91 115 117 122 140 159 160 184 212 223 817 890 930 949 988 1032 1086 1104 1162 1168 1223 1267 1270 1277 1284 1328 1345 1352 1388 1389 1390 1394 1396 1405 1442 1454 1471 1504 1522 1524 1553 1554 1563 1582 1583}.

If a frequency-domain density of a DMRS is ½, in other words, every two carriers are mapped to one DMRS on one symbol, to be specific, the DMRS is communicated on the 1^{st} carrier, the 3^{rd} carrier, the 5^{th} carrier, the 7^{th} carrier, the 9^{th} carrier, . . . , and the like, the first communication device punctures the first tone reservation pattern to obtain a punctured fifth tone reservation pattern: {2 28 40 42 68 72 82 84 122 140 160 184 212 890 930 988 1032 1086 1104 1162 1168 1270 1284 1328 1352 1388 1390 1394 1396 1442 1454 1504 1522 1524 1554 1582}.
Step 202b: The first communication device communicates the data signal by using the fifth tone reservation pattern.

For example, the first communication device is a terminal device. A tone reservation pattern shown in FIG. 11 includes a carrier 1, a carrier 4, a carrier 5, a carrier 8, and a carrier 10. These carriers are all reserved carriers. In other words, the terminal device does not communicate a data signal on these carriers. A DMRS pattern shown in FIG. 11 indicates that the terminal device receives DMRSs from a network device on the carrier 1, a carrier 3, the carrier 5, a carrier 7, a carrier 9, and a carrier 11. Therefore, the carrier 1 and the carrier 5 are overlapping reserved carriers. The terminal device may puncture the carrier 1 and the carrier 5 in the tone reservation pattern to obtain a punctured tone reservation pattern. Specifically, as shown in FIG. 11, a punctured tone reservation pattern includes the carrier 4, the carrier 8, and the carrier 10.

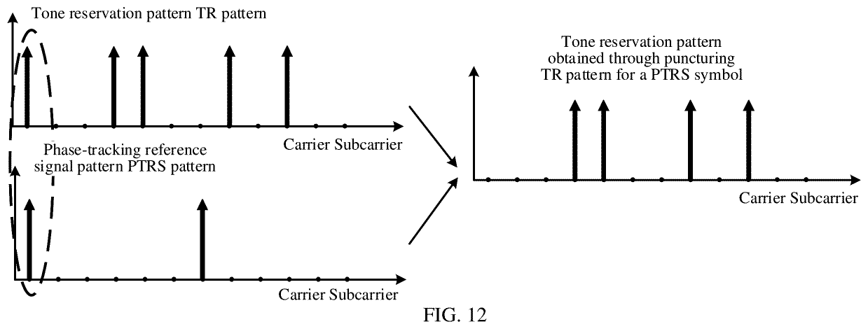

For example, the first communication device is the terminal device. A tone reservation pattern shown in FIG. 12 includes a carrier 1, a carrier 4, a carrier 5, a carrier 8, and a carrier 10. These carriers are all reserved carriers included in the tone reservation pattern. The terminal device does not communicate a data signal on these carriers. A PTRS pattern shown in FIG. 12 indicates that the terminal device receives PTRSs from a network device on the carrier 1 and a carrier 7. Therefore, the carrier 1 is an overlapping reserved carrier in the tone reservation pattern. The terminal device may puncture the carrier 1 in the tone reservation pattern to obtain a punctured tone reservation pattern. Specifically, as shown in FIG. 12, a punctured tone reservation pattern includes the carrier 4, the carrier 5, the carrier 8, and the carrier 10.

It can be learned that the first communication device punctures a first tone reservation pattern, and then communicates the data signal by using a fifth tone reservation pattern obtained through puncturing. In other words, this application provides a new rule for using the tone reservation pattern, and the tone reservation pattern has a puncturing feature. The first communication device does not need to store or configure a plurality of sets of tone reservation patterns, to reduce storage overheads of the first communication device.

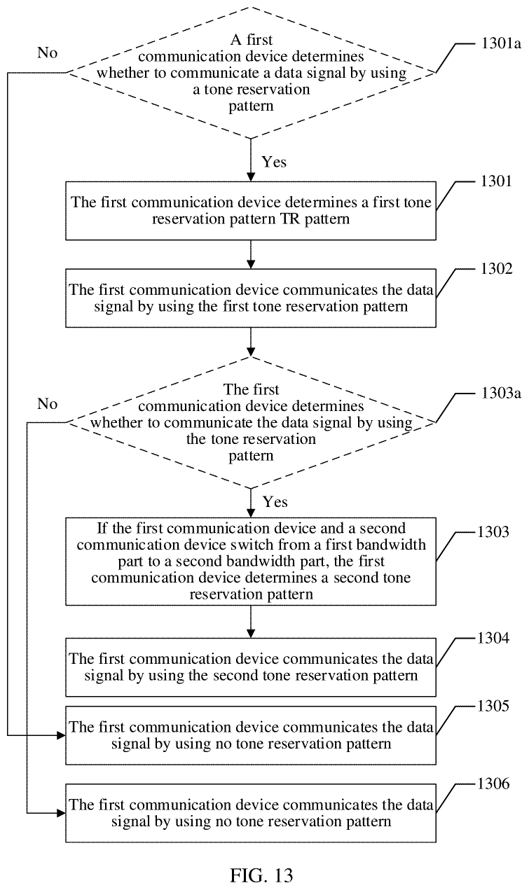

In this application, if the first communication device switches from the first bandwidth part to the second bandwidth part, the first communication device may update the tone reservation pattern. The following describes operations performed by the first communication device with reference to the embodiment shown in FIG. 13.

FIG. 13 is a schematic diagram of another embodiment of a communication processing method according to an embodiment of this application. Refer to FIG. 13. The communication processing method includes the following steps.
1301: A first communication device determines a first tone reservation pattern.

Step 1301 is similar to step 201 in the embodiment shown in FIG. 2. For details, refer to the related descriptions of step 201 in the embodiment shown in FIG. 2. Details are not described herein again.

Optionally, the embodiment shown in FIG. 13 further includes step 1301a and step 1305. Step 1301a may be performed before step 1301.
1301a: The first communication device determines whether to communicate a data signal by using a tone reservation pattern, and if the first communication device determines to communicate the data signal by using the tone reservation pattern, step 1301 is performed; or if the first communication device determines to communicate the data signal by using no tone reservation pattern, step 1305 is performed.

Step 1301a and step 1305 are similar to step 201a and step 203 in the embodiment shown in FIG. 2. For details, refer to the related descriptions of step 201a and step 203 in the embodiment shown in FIG. 2. Details are not described herein again.
1302: The first communication device communicates the data signal by using the first tone reservation pattern.

Step 1302 is similar to step 202 in the embodiment shown in FIG. 2. For details, refer to the related descriptions of step 202 in the embodiment shown in FIG. 2. Details are not described herein again.
1303: If the first communication device and a second communication device switch from a first bandwidth part to a second bandwidth part, the first communication device determines a second tone reservation pattern based on the second bandwidth part.

In step 1303, a manner in which the first communication device determines the second tone reservation pattern is similar to manners in which the first communication device determines the first tone reservation pattern in embodiments shown in FIG. 4 and FIG. 5. For details, refer to the related descriptions in embodiments shown in FIG. 4 and FIG. 5. Details are not described herein again.

For example, the first bandwidth part is a bandwidth part corresponding to an index 0, and the second bandwidth part is a bandwidth part corresponding to an index 1. The first communication device may determine, based on the index 1 and Table 2, that the second tone reservation pattern is {4 10 13 22 28 37 39 58 89 109 123 140 154 161 166 189 190 193 207 214 229 290 323 325 327 335 817 911 965 1035 1065 1170 1181 1282 1288 1317 1348 1386 1397 1412 1414 1419 1440 1461 1464 1466 1467 1469 1512 1534 1541 1543 1544 1550 1551 1553 1568}.

Optionally, the embodiment shown in FIG. 13 further includes step 1303a and step 1306. Step 1303a may be performed before step 1303.
1303a: The first communication device determines whether to communicate the data signal by using the tone reservation pattern, and if the first communication device determines to communicate the data signal by using the tone reservation pattern, step 1303 is performed; or if the first communication device determines to communicate the data signal by using no tone reservation pattern, step 1306 is performed.

Specifically, if the first communication device and the second communication device switch from the first bandwidth part to the second bandwidth part, the first communication device determines whether to communicate the data signal by using the tone reservation pattern. If the first communication device determines to communicate the data signal by using the tone reservation pattern, step 1303 is performed; or if the first communication device determines to communicate the data signal by using no tone reservation pattern, step 1306 is performed.

Step 1303a is similar to step 201a in the embodiment shown in FIG. 2. For details, refer to the related descriptions of step 201a in the embodiment shown in FIG. 2. Details are not described herein again.
1304: The first communication device communicates the data signal based on the second tone reservation pattern.
1305: The first communication device communicates the data signal by using no tone reservation pattern.

Step 1304 and step 1305 are similar to step 202 and step 203 in the embodiment shown in FIG. 2. For details, refer to the related descriptions of step 202 and step 203 in the embodiment shown in FIG. 2. Details are not described herein again.
1306: The first communication device communicates the data signal by using no tone reservation pattern.

Step 1306 is similar to step 203 in the embodiment shown in FIG. 2. For details, refer to the related descriptions of step 203 in the embodiment shown in FIG. 2. Details are not described herein again.

It should be noted that after step 1304, if the first communication device and the second communication device switch from the second bandwidth part to a third bandwidth part, operations performed by the first communication device are similar to operations in step 1303a to step 1304 and step 1306. Details are not described herein again. For this embodiment, correspondingly, an operation performed by the second communication device is similar to an operation performed by the first communication device in the embodiment shown in FIG. 13. Details are not described herein again.

For example, as shown in FIG. 3, the first communication device is a terminal device. In an initial access process, the terminal device initiates initial access to a network device by using a tone reservation pattern 1 corresponding to an initial bandwidth part. After the terminal device accesses a network, the terminal device switches from the initial bandwidth part to a bandwidth part 1. The terminal device performs data communication with the network device by using a tone reservation pattern 2 corresponding to the bandwidth part 1. Then, the terminal device switches from the bandwidth part 1 to a bandwidth part 2. The terminal device performs data communication with the network device by using a tone reservation pattern 3 corresponding to the bandwidth part 2.

This application further provides an embodiment. This embodiment is similar to the embodiment shown in FIG. 13, and a difference lies in step 1303 and step 1304 in the embodiment shown in FIG. 13. Step 1303 is replaced with step 1303b, and step 1304 is replaced with step 1304a.
Step 1303b: If a first communication device and a second communication device switch from a first beam to a second beam, the first communication device determines a third tone reservation pattern based on the second beam.

For example, a beam number of the first beam is 1, and a beam number of the second beam is 2. The first communication device may determine, by using Table 4 and the beam number of the second beam, that the third tone reservation pattern is {2 4 6 7 8 10 11 14 16 18 20 28 30 31 32 35 38 40 138 139 154 156 160 174 175 195 196 200 211 212 214 216 220 222 223 228 230 232 236 239}.

In step 1303b, a manner in which the first communication device determines the third tone reservation pattern is similar to a manner in which the first communication device determines the first tone reservation pattern in the embodiment shown in FIG. 6. For details, refer to the related descriptions of the embodiment shown in FIG. 6. Details are not described herein again.
Step 1304a: The first communication device communicates a data signal by using the third tone reservation pattern.

Step 1304a is similar to step 1304 in the embodiment shown in FIG. 13. For details, refer to the related descriptions of step 1304 in the embodiment shown in FIG. 13. Details are not described herein again. For this embodiment, correspondingly, operations performed by the second communication device are similar. Details are not described herein again.

This application further provides an embodiment. This embodiment is similar to the embodiment shown in FIG. 13, and a difference lies in step 1303 and step 1304 in the embodiment shown in FIG. 13. Step 1303 is replaced with step 1303c, and step 1304 is replaced with step 1304b.
1303c: If a first communication device and a second communication device switch, on a first beam, from a first bandwidth part to a third bandwidth part, the first communication device determines a fourth tone reservation pattern based on the third bandwidth part.

The first beam corresponds to a plurality of bandwidth parts. Each bandwidth part corresponds to one tone reservation pattern. The plurality of bandwidth parts include the first bandwidth part and the third bandwidth part.

For example, if a beam number of the first beam is 0, an index of the first bandwidth part is 0, and an index of a second bandwidth part is 1, the first communication device may determine, based on the first beam, the second bandwidth part, and Table 5, that the fourth tone reservation pattern is {5 6 7 11 29 31 71 79 83 85 99 111 138 161 166 181 183 194 210 240 263 272 301 305 800 959 985 988 1001 1160 1203 1225 1244 1265 1298 1334 1343 1372 1377 1385 1390 1401 1405 1439 1448 1455 1472 1481 1482 1514 1527 1544 1555 1562 1563 1564 1571}.
Step 1303c: A manner in which the first communication device determines the fourth tone reservation pattern is similar to a manner in which the first communication device determines the first tone reservation pattern in the embodiment shown in FIG. 8. For details, refer to the related descriptions of the embodiment shown in FIG. 8. Details are not described herein again.
Step 1304b: The first communication device communicates a data signal by using the fourth tone reservation pattern.
Step 1304b is similar to step 1304 in the embodiment shown in FIG. 13. For details, refer to the related descriptions of step 1304 in the embodiment shown in FIG. 13. Details are not described herein again. For this embodiment, correspondingly, operations performed by the second communication device are similar. Details are not described herein again.

This application further provides an embodiment. This embodiment is similar to the embodiment shown in FIG. 13, and a difference lies in step 1303 and step 1304 in the embodiment shown in FIG. 13. Step 1303 is replaced with step 1303d, and step 1304 is replaced with step 1304c.
Step 1303d: If a first communication device and a second communication device switch from a first beam to a second beam, and switch from a first bandwidth part to a third bandwidth part, the first communication device determines a sixth tone reservation pattern based on the second beam and the third bandwidth part.

In a possible implementation, the first beam and the second beam each correspond to a plurality of bandwidth parts. The plurality of bandwidth parts include the first bandwidth part and a second bandwidth part. For example, in the embodiment shown in FIG. 8, it can be learned that the first communication device may determine, from a third mapping relationship, a mapping relationship between a tone reservation pattern and the plurality of bandwidth parts corresponding to the second beam. Then, the first communication device determines, based on the mapping relationship between a tone reservation pattern and the plurality of bandwidth parts corresponding to the second beam, a tone reservation pattern that is in a plurality of tone reservation patterns and that corresponds to the second beam and the second bandwidth part.

For example, if a beam number of the second beam is 1, and an index of the second bandwidth part is 1, the first communication device may determine, based on the second beam, the second bandwidth part, and Table 5, that the sixth tone reservation pattern is {2 3 13 19 20 29 39 44 45 69 79 89 94 105 136 141 157 213 220 246 293 912 919 1003 1073 1085 1138 1145 1146 1181 1236 1264 1269 1302 1308 1396 1402 1449 1452 1506 1507 1516 1521 1532 1533 1549 1550 1557 1564 1575 1583}.
Step 1304c: The first communication device communicates a data signal by using the sixth tone reservation pattern.
Step 1304c is similar to step 1304 in the embodiment shown in FIG. 13. For details, refer to the related descriptions of step 1304 in the embodiment shown in FIG. 13. Details are not described herein again. For this embodiment, correspondingly, operations performed by the second communication device are similar. Details are not described herein again.

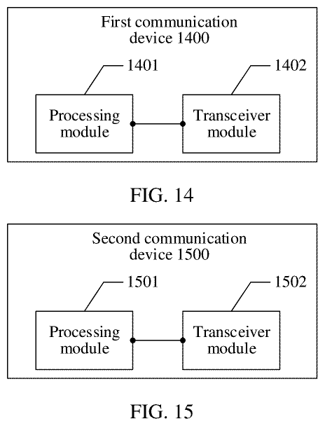

The following describes the first communication device provided in embodiments of this application. FIG. 14 is a schematic diagram of a structure of a first communication device according to an embodiment of this application. The first communication device may be configured to perform steps performed by the first communication device in the embodiments shown in FIG. 2, FIG. 4, FIG. 5, FIG. 6, FIG. 8, FIG. 10, and FIG. 13. For details, refer to the related descriptions in the foregoing method embodiments.

The first communication device 1400 includes a processing module 1401 and a transceiver module 1402.

The processing module 1401 is configured to determine a first tone reservation pattern.

The transceiver module 1402 is configured to communicate a data signal by using the first tone reservation pattern. The first tone reservation pattern is determined based on a first bandwidth part, or the first tone reservation pattern is determined based on a first beam. The first bandwidth part is used for communicating the data signal between the first communication device and a second communication device, and the first beam is used for communicating the data signal between the first communication device and the second communication device.

In a possible implementation, the processing module 1401 is specifically configured to:
obtain first configuration information, where the first configuration information indicates the first tone reservation pattern corresponding to the first bandwidth part; and
determine the first tone reservation pattern based on the first configuration information.

In another possible implementation, the processing module 1401 is specifically configured to:
determine, from a plurality of tone reservation patterns based on a first mapping relationship, the first tone reservation pattern corresponding to the first bandwidth part, where the first mapping relationship is a correspondence between a tone reservation pattern and a bandwidth part.

In another possible implementation, the processing module 1401 is specifically configured to:
determine, from a plurality of tone reservation patterns based on a second mapping relationship, the first tone reservation pattern corresponding to the first beam, where the second mapping relationship is a mapping relationship between a tone reservation pattern and a beam.

In another possible implementation, the processing module 1401 is specifically configured to:
determine, from a plurality of tone reservation patterns based on a third mapping relationship, the first tone reservation pattern corresponding to the first bandwidth part, where the third mapping relationship includes a mapping relationship between a tone reservation pattern and a plurality of bandwidth parts corresponding to each of a plurality of beams.

In another possible implementation, the processing module 1401 is specifically configured to:
determine, from a plurality of tone reservation patterns based on a fourth mapping relationship and the first bandwidth part, a tone reservation pattern corresponding to a first reference signal pattern, where the fourth mapping relationship is a mapping relationship that is between a tone reservation pattern and a reference signal pattern and that is used when the first communication device and the second communication device use each of a plurality of bandwidth parts.

In another possible implementation, the processing module 1401 is further configured to:
determine whether to communicate the data signal by using the tone reservation pattern; and
if the processing module determines to communicate the data signal by using the tone reservation pattern, the step in which the processing module 1401 determines the first tone reservation pattern is performed.

In another possible implementation, the processing module is specifically configured to:
obtain first indication information; and
determine, based on the first indication information, whether to communicate the data signal by using the tone reservation pattern.

In another possible implementation, the first indication information is carried in a broadcast message.

In another possible implementation, the broadcast message includes a SIB 1 or a MIB.

In another possible implementation, the first indication information indicates location information of a third communication device, where the third communication device is used for communicating between the first communication device and the second communication device.

The processing module 1401 is specifically configured to:
determine, based on the location information of the third communication device, whether to communicate the data signal by using the tone reservation pattern.

In another possible implementation, the first indication information indicates to the first communication device whether to communicate, by using the tone reservation pattern, a data signal carried in each of a plurality of beams, where the plurality of beams include the first beam.

In another possible implementation, if the first communication device and the second communication device switch from the first bandwidth part to a second bandwidth part, the processing module 1401 is further configured to:
determine a second tone reservation pattern based on the second bandwidth part.

The transceiver module 1402 is further configured to: communicate the data signal based on the second tone reservation pattern.

In another possible implementation, if the first communication device and the second communication device switch from the first beam to a second beam, the processing module 1401 is further configured to:
correspondingly determine a third tone reservation pattern based on the second beam.

The transceiver module 1402 is further configured to:
communicate the data signal based on the second tone reservation pattern.

In another possible implementation, the first beam corresponds to the first bandwidth part and a third bandwidth part, the first bandwidth part corresponds to the first tone reservation pattern, and the third bandwidth part corresponds to a fourth tone reservation pattern. If the first communication device and the second communication device switch, on the first beam, from the first bandwidth part to the third bandwidth part, the processing module 1401 is further configured to:
determine the fourth tone reservation pattern based on the third bandwidth part.

The transceiver module 1402 is further configured to:
communicate the data signal based on the fourth tone reservation pattern.

In another possible implementation, if on a same time domain resource, a reserved carrier in the first tone reservation pattern overlaps a carrier that is on the first communication device and that is used for communicating a reference signal, the transceiver module 1402 is specifically configured to:
puncture an overlapping reserved carrier in the first tone reservation pattern to obtain a fifth tone reservation pattern, where the overlapping reserved carrier is a reserved carrier that is in the first tone reservation pattern and that overlaps the carrier used for communicating the reference signal.
communicate the data signal based on a fifth tone reservation pattern.

In another possible implementation, the transceiver module 1402 is further configured to:
obtain second configuration information, where the second configuration information includes at least one of the following configuration parameters: a plurality of tone reservation patterns, indexes of the plurality of tone reservation patterns, a mapping relationship between the tone reservation pattern and the reference signal pattern when the first communication device and the second communication device use each of the plurality of bandwidth parts, the mapping relationship between the tone reservation pattern and the bandwidth part, the mapping relationship between the tone reservation pattern and the beam, and the mapping relationship between the tone reservation pattern and the plurality of bandwidth parts corresponding to the beam.

In another possible implementation, any one of the configuration parameters included in the second configuration information is carried in any one of the following signaling: a SIB 1, a MIB, RRC signaling, DCI, group DCI, a MAC CE, or a TAC.

The following describes the second communication device provided in embodiments of this application. FIG. 15 is a schematic diagram of a structure of a second communication device according to an embodiment of this application. The second communication device may be configured to perform steps performed by the second communication device in the embodiment shown in FIG. 2. For details, refer to the related descriptions in the foregoing method embodiments. The second communication device 1500 includes a processing module 1501 and a transceiver module 1502.

The processing module 1501 is configured to determine a first tone reservation pattern.

The transceiver module 1502 is configured to communicate a data signal by using the first tone reservation pattern. The first tone reservation pattern is determined based on a first bandwidth part, or the first tone reservation pattern is determined based on a first beam. The first bandwidth part is used for communicating the data signal between a first communication device and the second communication device, and the first beam is used for communicating the data signal between the first communication device and the second communication device.

In a possible implementation, the processing module 1501 is specifically configured to:
determine, from a plurality of tone reservation patterns based on a first mapping relationship, the first tone reservation pattern corresponding to the first bandwidth part, where the first mapping relationship is a correspondence between a tone reservation pattern and a bandwidth part.

In another possible implementation, the processing module 1501 is specifically configured to:
determine, from a plurality of tone reservation patterns based on a second mapping relationship, the first tone reservation pattern corresponding to the first beam, where the second mapping relationship is a mapping relationship between a tone reservation pattern and a beam.

In another possible implementation, the processing module 1501 is specifically configured to:
determine, from the plurality of tone reservation patterns based on a third mapping relationship, the first tone reservation pattern corresponding to the first bandwidth part, where the third mapping relationship includes a mapping relationship between a tone reservation pattern and a plurality of bandwidth parts corresponding to each of a plurality of beams.

In another possible implementation, a reference signal is communicated between the first communication device and the second communication device by using a first reference signal pattern. The processing module 1501 is specifically configured to:
determine, from a plurality of tone reservation patterns based on a fourth mapping relationship and the first bandwidth part, a tone reservation pattern corresponding to a first reference signal pattern, where the fourth mapping relationship is a mapping relationship that is between a tone reservation pattern and a reference signal pattern and that is used when the first communication device and the second communication device use each of a plurality of bandwidth parts.

In another possible implementation, the transceiver module 1502 is further configured to:
send first configuration information to the first communication device, where the first configuration information indicates the first tone reservation pattern corresponding to the first bandwidth part.

In another possible implementation, the transceiver module 1502 is further configured to:
send first indication information to the first communication device, where the first indication information indicates whether to communicate the data signal by using a tone reservation pattern.

In another possible implementation, the first indication information is carried in a broadcast message.

In another possible implementation, the first indication information indicates location information of a third communication device, where the third communication device is used for communicating between the first communication device and the second communication device. Alternatively,
the first indication information indicates to the first communication device whether to communicate, by using the tone reservation pattern, the data signal carried in each of a plurality of beams, where the plurality of beams include the first beam.

In another possible implementation, if the first communication device and the second communication device switch from the first bandwidth part to a second bandwidth part, the processing module 1501 is further configured to:
determine a second tone reservation pattern based on the second bandwidth part.

The transceiver module 1502 is further configured to:
communicate the data signal based on the second tone reservation pattern.

In another possible implementation, if the first communication device and the second communication device switch from the first beam to a second beam, the processing module 1501 is further configured to:
correspondingly determine a third tone reservation pattern based on the second beam.

The transceiver module 1502 is further configured to:
communicate the data signal based on the second tone reservation pattern.

In another possible implementation, the first beam corresponds to the first bandwidth part and a third bandwidth part, the first bandwidth part corresponds to the first tone reservation pattern, and the third bandwidth part corresponds to a fourth tone reservation pattern. If the first communication device and the second communication device switch, on the first beam, from the first bandwidth part to the third bandwidth part, the processing module 1501 is further configured to:
determine the fourth tone reservation pattern based on the third bandwidth part.

The transceiver module 1502 is further configured to:
communicate the data signal based on the fourth tone reservation pattern.

In another possible implementation, if on a same time domain resource, a reserved carrier in the first tone reservation pattern overlaps a carrier that is on the first communication device and that is used for communicating a reference signal, the processing module 1501 is specifically configured to:
puncture an overlapping reserved carrier in the first tone reservation pattern to obtain a fifth tone reservation pattern, where the overlapping reserved carrier is a reserved carrier that is in the first tone reservation pattern and that overlaps the carrier used for communicating the reference signal.

The transceiver module 1502 is further configured to:
communicate the data signal based on a fifth tone reservation pattern.

In another possible implementation, the transceiver module 1502 is further configured to:
send second configuration information to the first communication device, where the second configuration information includes at least one of the following configuration parameters: a plurality of tone reservation patterns, indexes of the plurality of tone reservation patterns, a mapping relationship between the tone reservation pattern and a reference signal pattern when the first communication device and the second communication device use each of a plurality of bandwidth parts, a mapping relationship between the tone reservation pattern and a bandwidth part, a mapping relationship between the tone reservation pattern and a beam, and a mapping relationship between the tone reservation pattern and the plurality of bandwidth parts corresponding to the beam.

In another possible implementation, any one of the configuration parameters included in the second configuration information is carried in any one of the following signaling: a SIB 1, a MIB, RRC signaling, DCI, group DCI, a MAC CE, or a TAC.

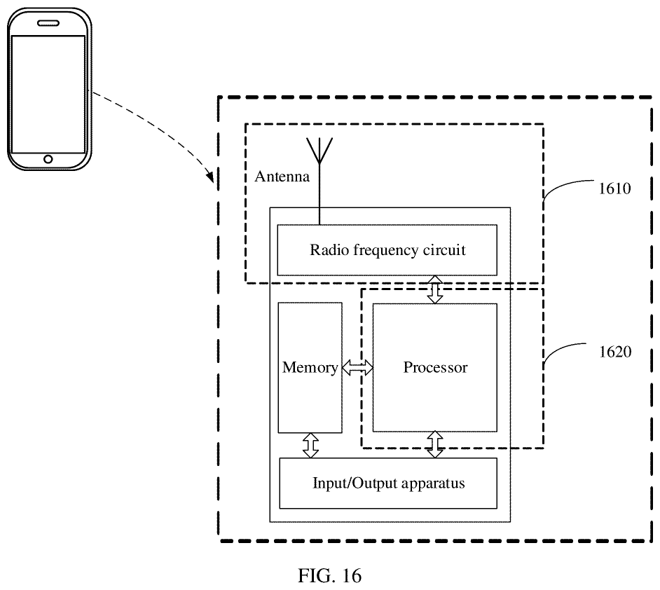

The following is a possible schematic diagram of a structure in which the first communication device is the terminal device by using FIG. 16.

FIG. 16 is a simplified schematic diagram of a structure of a terminal device. For ease of understanding and illustration, an example in which the terminal device is a mobile phone is used in FIG. 16. As shown in FIG. 16, the terminal device includes a processor, a memory, a radio frequency circuit, an antenna, and an input/output apparatus.

The processor is mainly configured to: process a communication protocol and communication data, control the terminal device, execute a software program, process data of the software program, and the like.

The memory is mainly configured to store the software program and data. The radio frequency circuit is mainly configured to: perform conversion between a baseband signal and a radio frequency signal, and process the radio frequency signal. The antenna is mainly configured to receive and send a radio frequency signal in a form of an electromagnetic wave.

The input/output apparatus, such as a touchscreen, a display, or a keyboard, is mainly configured to: receive data input by a user and output data to the user. It should be noted that some types of terminal devices may have no input/output apparatus.

When needing to send data, after performing baseband processing on the to-be-sent data, the processor outputs a baseband signal to the radio frequency circuit; and the radio frequency circuit performs radio frequency processing on the baseband signal and then sends the radio frequency signal to the outside in a form of an electromagnetic wave through the antenna. When data is sent to the terminal device, the radio frequency circuit receives the radio frequency signal through the antenna, converts the radio frequency signal into a baseband signal, and outputs the baseband signal to the processor. The processor converts the baseband signal into data, and processes the data.

For ease of description, FIG. 16 shows only one memory and one processor. In an actual terminal device product, there may be one or more processors and one or more memories. The memory may also be referred to as a storage medium, a storage device, or the like. The memory may be disposed independent of the processor, or may be integrated with the processor. This is not limited in embodiments of this application.

In this embodiment of this application, the antenna and a radio frequency circuit that have a transceiver function may be considered as a transceiver unit of the terminal device, and a processor that has a processing function may be considered as a processing unit of the terminal device. As shown in FIG. 16, the terminal device includes a transceiver unit 1610 and a processing unit 1620. The transceiver unit may also be referred to as a transceiver, a transceiver device, a transceiver apparatus, or the like. The processing unit may also be referred to as a processor, a processing board, a processing module, a processing apparatus, or the like. Optionally, a component that is in the transceiver unit 1610 and that is configured to implement a receiving function may be considered as a receiving unit, and a component that is in the transceiver unit 1610 and that is configured to implement a transmitting function may be considered as a sending unit. In other words, the transceiver unit 1610 includes the receiving unit and the sending unit. The transceiver unit sometimes may also be referred to as a transceiver machine, a transceiver, a transceiver circuit, or the like. The receiving unit sometimes may also be referred to as a receiver machine, a receiver, a receive circuit, or the like. The sending unit sometimes may also be referred to as a transmitting machine, a transmitter, a transmitting circuit, or the like.

It should be understood that the transceiver unit 1610 is configured to perform a transmitting operation and a receiving operation of the first communication device in the foregoing method embodiments, and the processing unit 1620 is configured to perform an operation other than the receiving and transmitting operations of the first communication device in the foregoing method embodiments.

When the terminal device is a chip, the chip includes a transceiver unit and a processing unit. The transceiver unit may be an input/output circuit or a communication interface. The processing unit is a processor, a microprocessor, an integrated circuit, or a logical circuit integrated on the chip.

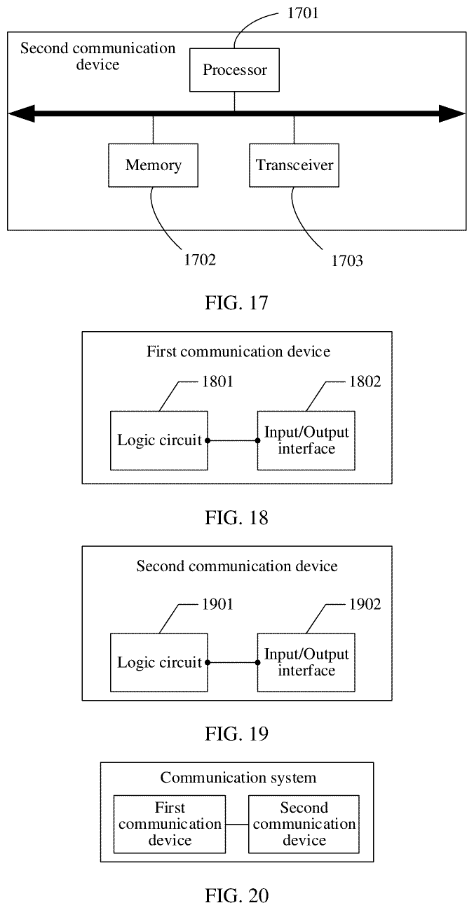

This application further provides a second communication device. FIG. 17 is a schematic diagram of another structure of the second communication device according to an embodiment of this application. The second communication device may be configured to perform steps performed by the second communication device in the embodiment shown in FIG. 2. For details, refer to the related descriptions in the foregoing method embodiments.

The second communication device 1700 includes a processor 1701 and a memory 1702. Optionally, the second communication apparatus further includes a transceiver 1703.

In a possible implementation, the processor 1701, the memory 1702, and the transceiver 1703 are separately connected by using a bus. The memory stores computer instructions.

The processing module 1501 in the foregoing embodiment may specifically be the processor 1701 in this embodiment. Therefore, specific implementation of the processor 1701 is not described. The transceiver module 1502 in the foregoing embodiment may be specifically the transceiver 1703 in this embodiment. Therefore, specific implementation of the transceiver 1703 is not described.

FIG. 18 is a schematic diagram of another structure of a first communication device according to an embodiment of this application. Refer to FIG. 18. The first communication device includes a logic circuit 1801 and an input/output interface 1802. The first communication device shown in FIG. 18 may be configured to perform steps performed by the first communication device in the embodiments shown in FIG. 2, FIG. 4, FIG. 5, FIG. 6, FIG. 8, FIG. 10, and FIG. 13.

Optionally, the logic circuit 1802 may have a function of the processing module 1401 in the embodiment shown in FIG. 14. The input/output interface 1802 may have a function of the transceiver module 1402 in the embodiment shown in FIG. 14.

The first communication device shown in FIG. 18 may perform the technical solutions shown in the foregoing method embodiments. For a similar implementation principle and similar beneficial effects of the first communication device shown in FIG. 18, details are not described herein again.

FIG. 19 is a schematic diagram of another structure of a second communication device according to an embodiment of this application. Refer to FIG. 19. The second communication device includes a logic circuit 1901 and an input/output interface 1902. The second communication device shown in FIG. 19 may be configured to perform the steps performed by the second communication device in the embodiment shown in FIG. 2.

Optionally, the logic circuit 1902 may have a function of the processing module 1501 in the embodiment shown in FIG. 15. The input/output interface 1902 may have a function of the transceiver module 1502 in the embodiment shown in FIG. 15.

The second communication device shown in FIG. 19 may perform the technical solutions shown in the foregoing method embodiments. For a similar implementation principle and similar beneficial effects of the first communication device shown in FIG. 19, details are not described herein again.

Refer to FIG. 20. An embodiment of this application further provides a communication system. The communication system includes the first communication device shown in FIG. 14 and the second communication device shown in FIG. 15. The first communication device shown in FIG. 14 may be configured to perform all or some of steps performed by the first communication device in the embodiments shown in FIG. 2, FIG. 4, FIG. 5, FIG. 6, FIG. 8, FIG. 10, and FIG. 13. The second communication device shown in FIG. 15 may be configured to perform all or some of the steps performed by the second communication device in the embodiment shown in FIG. 2.

An embodiment of this application further provides a computer program product including instructions. When the computer program product runs on a computer, the computer is enabled to perform the communication processing methods in the embodiments shown in FIG. 2, FIG. 4, FIG. 5, FIG. 6, FIG. 8, FIG. 10, and FIG. 13.

An embodiment of this application further provides a computer-readable storage medium, including computer instructions. When the computer instructions are run on a computer, the computer performs the communication processing methods in the embodiments shown in FIG. 2, FIG. 4, FIG. 5, FIG. 6, FIG. 8, FIG. 10, and FIG. 13.

An embodiment of this application further provides a chip apparatus, including a processor, configured to connect to a memory, and invoke a program stored in the memory, to enable the processor to perform the communication processing methods in the embodiments shown in FIG. 2, FIG. 4, FIG. 5, FIG. 6, FIG. 8, FIG. 10, and FIG. 13.

The processor included in any one of the foregoing descriptions may be a general-purpose central processing unit, a microprocessor, an application-specific integrated circuit (application-specific integrated circuit, ASIC), or one or more integrated circuits configured to control program execution of the communication processing methods in the embodiments shown in FIG. 2, FIG. 4, FIG. 5, FIG. 6, FIG. 8, FIG. 10, and FIG. 13. The memory mentioned anywhere above may be a read-only memory (read-only memory, ROM), another type of static storage device that can store static information and instructions, a random access memory (random access memory, RAM), or the like.

It may be clearly understood by a person skilled in the art that for the purpose of convenient and brief description, for a detailed working process of the foregoing system, apparatus, and unit, refer to a corresponding process in the foregoing method embodiments. Details are not described herein again.

In several embodiments provided in this application, it should be understood that the disclosed system, apparatus, and method may be implemented in other manners. For example, the described apparatus embodiment is merely an example. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in the embodiments of this application may be integrated into one processing unit, each of the units may exist alone physically, or two or more units are integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions of this application essentially, or the part contributing to a current technology, or all or some of the technical solutions may be implemented in the form of a software product. The computer software product is stored in a storage medium and includes several instructions for instructing a computer device (which may be a personal computer, a server, or a network device) to perform all or some of the steps of the methods described in embodiments of this application. The foregoing storage medium includes any medium that can store program code, for example, a USB flash drive, a removable hard disk drive, a read-only memory (read-only memory, ROM), a random access memory (random access memory, RAM), a magnetic disk, or an optical disc.

In conclusion, the foregoing embodiments are merely intended for describing the technical solutions of this application, but not for limiting this application. Although this application is described in detail with reference to the foregoing embodiments, a person of ordinary skill in the art should understand that they may still make modifications to the technical solutions described in the foregoing embodiments or make equivalent replacements to some technical features thereof, without departing from the scope of the technical solutions of embodiments of this application.

What is claimed is:

1. A communication processing method, wherein the method comprises:
determining, by a first communication device, a first tone reservation pattern; and
communicating, by the first communication device, a data signal by using the first tone reservation pattern, wherein
the first tone reservation pattern is determined based on a first bandwidth part BWP, or the first tone reservation pattern is determined based on a first beam; and
the first bandwidth part is used for communicating the data signal between the first communication device and a second communication device, and the first beam is used for communicating the data signal between the first communication device and the second communication device.

2. The method according to claim 1, wherein the determining, by a first communication device, a first tone reservation pattern comprises:
obtaining, by the first communication device, first configuration information, wherein the first configuration information indicates the first tone reservation pattern corresponding to the first bandwidth part; and
determining, by the first communication device, the first tone reservation pattern based on the first configuration information.

3. The method according to claim 1, wherein the determining, by a first communication device, a first tone reservation pattern comprises:
determining, by the first communication device from a plurality of tone reservation patterns based on a first mapping relationship, the first tone reservation pattern corresponding to the first bandwidth part, wherein the first mapping relationship is a mapping relationship between a tone reservation pattern and a bandwidth part.

4. The method according to claim 1, wherein the determining, by a first communication device, a first tone reservation pattern comprises:
determining, by the first communication device from a plurality of tone reservation patterns based on a second mapping relationship, the first tone reservation pattern corresponding to the first beam, wherein the second mapping relationship is a mapping relationship between a tone reservation pattern and a beam.

5. The method according to claim 1, wherein the determining, by a first communication device, a first tone reservation pattern comprises:
determining, by the first communication device from a plurality of tone reservation patterns based on a third mapping relationship, the first tone reservation pattern corresponding to the first bandwidth part, wherein the third mapping relationship comprises a mapping relationship between a tone reservation pattern and a plurality of bandwidth parts corresponding to each of a plurality of beams.

6. The method according to claim 1, wherein a reference signal is communicated between the first communication device and the second communication device by using a first reference signal pattern; and the determining, by a first communication device, a first tone reservation pattern comprises:
determining, by the first communication device from a plurality of tone reservation patterns based on a fourth mapping relationship and the first bandwidth part, a tone reservation pattern corresponding to the first reference signal pattern, wherein the fourth mapping relationship is a mapping relationship that is between a tone reservation pattern and a reference signal pattern and that is used when the first communication device and the second communication device use each of a plurality of bandwidth parts.

7. The method according to claim 1, wherein before the determining, by a first communication device, a first tone reservation pattern, the method further comprises:
determining, by the first communication device, whether to communicate the data signal by using a tone reservation pattern; and
if the first communication device determines to communicate the data signal by using the tone reservation pattern, performing the step in which the first communication device determines the first tone reservation pattern.

8. The method according to claim 7, wherein the determining, by the first communication device, whether to communicate the data signal by using a tone reservation pattern comprises:
obtaining, by the first communication device, first indication information; and
determining, by the first communication device based on the first indication information, whether to communicate the data signal by using the tone reservation pattern.

9. The method according to claim 1, wherein if the first communication device and the second communication device switch from the first bandwidth part BWP to a second bandwidth part BWP, the method further comprises:
determining, by the first communication device, a second tone reservation pattern based on the second bandwidth part; and
communicating, by the first communication device, the data signal based on the second tone reservation pattern.

10. The method according to claim 1, wherein if the first communication device and the second communication device switch from the first beam to a second beam, the method further comprises:
correspondingly determining, by the first communication device, a third tone reservation pattern based on the second beam; and
communicating, by the first communication device, the data signal based on the second tone reservation pattern.

11. The method according to claim 1, wherein the first beam corresponds to the first bandwidth part BWP and a third bandwidth part BWP, the first bandwidth part BWP corresponds to the first tone reservation pattern, and the third bandwidth part BWP corresponds to a fourth tone reservation pattern; and
if the first communication device and the second communication device switch, on the first beam, from the first bandwidth part BWP to the third bandwidth part BWP, the method further comprises:
determining, by the first communication device, the fourth tone reservation pattern based on the third bandwidth part BWP; and
communicating, by the first communication device, the data signal based on the fourth tone reservation pattern.

12. The method according to claim 1, wherein if on a same time domain resource, a reserved carrier in the first tone reservation pattern overlaps a carrier that is on the first communication device and that is used for communicating the reference signal, the communicating, by the first communication device, a data signal by using the first tone reservation pattern comprises:
puncturing, by the first communication device, an overlapping reserved carrier in the first tone reservation pattern to obtain a fifth tone reservation pattern, wherein the overlapping reserved carrier is a reserved carrier that is in the first tone reservation pattern and that overlaps the carrier used for communicating the reference signal; and
communicating, by the first communication device, the data signal based on the fifth tone reservation pattern.

13. The method according to claim 1, wherein the method further comprises:
obtaining, by the first communication device, second configuration information, wherein the second configuration information comprises at least one of the following configuration parameters: the plurality of tone reservation patterns, indexes of the plurality of tone reservation patterns, the mapping relationship between a tone reservation pattern and a reference signal pattern when the first communication device uses each of the plurality of bandwidth parts, the mapping relationship between a tone reservation pattern and a bandwidth part, the mapping relationship between a tone reservation pattern and a beam, and the mapping relationship between a tone reservation pattern and a plurality of bandwidth parts corresponding to a beam.

14. A communication processing method, wherein the method comprises:
determining, by a second communication device, a first tone reservation pattern; and
communicating, by the second communication device, a data signal by using the first tone reservation pattern, wherein
the first tone reservation pattern is determined based on a first bandwidth part BWP, or the first tone reservation pattern is determined based on a first beam; and
the first bandwidth part BWP is used for communicating the data signal between a first communication device and the second communication device, and the first beam is used for communicating the data signal between the first communication device and the second communication device.

15. The method according to claim 14, wherein the method further comprises:
sending, by the second communication device, first configuration information to the first communication device, wherein the first configuration information indicates the first tone reservation pattern corresponding to the first bandwidth part.

16. The method according to claim 14, wherein the method further comprises:
sending, by the second communication device, first indication information to the first communication device, wherein the first indication information indicates whether to communicate the data signal by using a tone reservation pattern.

17. The method according to claim 14, wherein the method further comprises:
sending, by the second communication device, second configuration information to the first communication device, wherein the second configuration information comprises at least one of the following configuration parameters: a plurality of tone reservation patterns, indexes of the plurality of tone reservation patterns, a mapping relationship between the tone reservation pattern and a reference signal pattern when the first communication device and the second communication device use each of a plurality of bandwidth parts, a mapping relationship between the tone reservation pattern and a bandwidth part, a mapping relationship between the tone reservation pattern and a beam, and a mapping relationship between the tone reservation pattern and a plurality of bandwidth parts corresponding to a beam.

18. A first communication device, wherein the first communication device comprises:
a processing module, configured to determine a first tone reservation pattern; and
a transceiver module, configured to communicate a data signal by using the first tone reservation pattern, wherein
the first tone reservation pattern is determined based on a first bandwidth part BWP, or the first tone reservation pattern is determined based on a first beam; and
the first bandwidth part is used for communicating the data signal between the first communication device and a second communication device, and the first beam is used for communicating the data signal between the first communication device and the second communication device.

19. The first communication device according to claim 18, wherein the processing module is specifically configured to:
obtain first configuration information, wherein the first configuration information indicates the first tone reservation pattern corresponding to the first bandwidth part; and
determine the first tone reservation pattern based on the first configuration information.

20. The first communication device according to claim 18, wherein the processing module is specifically configured to:
determine, from a plurality of tone reservation patterns based on a first mapping relationship, the first tone reservation pattern corresponding to the first bandwidth part, wherein the first mapping relationship is a mapping relationship between a tone reservation pattern and a bandwidth part.
